(19) United States
(12) Patent Application Publication
(10) Pub. No.: US 2025/0048004 A1
(43) Pub. Date: Feb. 6, 2025

(54) IMAGING DEVICE, ELECTRONIC EQUIPMENT, AND SIGNAL PROCESSING METHOD

(71) Applicant: SONY SEMICONDUCTOR SOLUTIONS CORPORATION, KANAGAWA (JP)

(72) Inventors: KATSUHIKO HANZAWA, KANAGAWA (JP); DAISUKE SAITO, KANAGAWA (JP)

(21) Appl. No.: 18/719,929

(22) PCT Filed: Nov. 15, 2022
(86) PCT No.: PCT/JP2022/042413

§ 371 Date: Jun. 14, 2024

(30) Foreign Application Priority Data
Dec. 22, 2021 (JP) 2021-208586

(51) Int. Cl. H04N 25/78; H04N 25/77; H04N 25/79

(52) U.S. Cl. CPC H04N 25/78; H04N 25/77; H04N 25/79

(57) ABSTRACT

An imaging device that can be reduced in size is provided. An imaging device according to an embodiment of the present disclosure includes a pixel array section configured to output a pixel signal obtained through photoelectric conversion of incident light, a memory array section configured to output a convolution signal indicating a result of a multiply-accumulate operation on an input signal based on the pixel signal, and a common circuit common to at least one of input and output sides of the pixel array section and the memory array section.

### TECHNICAL FIELD

The present disclosure relates to an imaging device, electronic equipment, and a signal processing method.

### BACKGROUND ART

In recent years, in order to achieve advanced tasks such as image recognition and object position detection, processors configured to perform calculations with deep neural networks (DNNs) implemented on their hardware have been put into practical use. CIM (Computing in memory), which performs calculations on a memory array section serving as a non-von Neumann architecture, has gained attention as a calculation method for DNNs.

### CITATION LIST

### Patent Literature

### [PTL 1]

Japanese Patent Laid-Open No. 2020-113809

### SUMMARY

### Technical Problem

In a case where a DNN combining a pixel array section with an imaging function and a memory array section with a multiply-accumulate operation function is performed, peripheral circuits such as a power supply circuit and an AD converter are arranged on the input and output sides of each array section. When the ratio of the area occupied by these peripheral circuits to the entire area of the device is high, it is difficult to reduce the device in size.

The present disclosure provides an imaging device that can be reduced in size, electronic equipment, and a signal processing method.

### Solution to Problem

An imaging device according to an embodiment of the present disclosure includes a pixel array section configured to output a pixel signal obtained through photoelectric conversion of incident light, a memory array section configured to output a convolution signal indicating a result of a multiply-accumulate operation on an input signal based on the pixel signal, and a common circuit common to at least one of input and output sides of the pixel array section and the memory array section.

The imaging device may further include a first selection circuit configured to select an electrical connection between the pixel array section and the common circuit, or an electrical connection between the memory array section and the common circuit.

The pixel array section may be disposed on a first substrate.

The memory array section may be disposed on a second substrate stacked on the first substrate.

An output direction of the pixel signal may be different from an output direction of the convolution signal.

The pixel signal and the convolution signal may each be an analog signal.

The common circuit may include an AD converter configured to convert the analog signal into a digital signal.

The common circuit may include a horizontal operation circuit configured to control the AD converter.

A plurality of the horizontal operation circuits may be provided for the single AD converter.

The pixel array section may have a plurality of pixels two-dimensionally arranged.

The memory array section may have a plurality of memory cells two-dimensionally arranged.

The common circuit may include a vertical drive circuit configured to select a pixel row and a memory cell row.

The vertical drive circuit may include a register, a first voltage adjustment section disposed between the register and the pixel array section, and a second voltage adjustment section disposed between the register and the memory array section.

The number of the first voltage adjustment sections may be different from the number of the second voltage adjustment sections.

The number of the first voltage adjustment sections may be the same as the number of the second voltage adjustment sections.

The imaging device may further include a second selection circuit configured to switch a connection destination of the vertical drive circuit to the pixel array section or the memory array section.

The common circuit may include a reference voltage generation circuit configured to generate a reference voltage within the imaging device.

The common circuit may include a power supply circuit configured to supply a power supply voltage to the pixel array section and the memory array section.

The common circuit may include a clock generation circuit configured to generate a clock for setting operating frequencies of the pixel array section and the memory array section.

The clock generation circuit may include a frequency divider for setting the operating frequencies different from each other to the pixel array section and the memory array section.

The common circuit may include a signal processing circuit configured to process signals obtained through digital conversion of the pixel signal and the convolution signal.

The imaging device may further include a first AD converter configured to digitally convert the pixel signal, a second AD converter configured to digitally convert the convolution signal, and a third selection circuit configured to select an electrical connection between the first AD converter and the signal processing circuit, or an electrical connection between the second AD converter and the signal processing circuit.

Electronic equipment according to an embodiment of the present disclosure includes an imaging device including a pixel array section configured to output a pixel signal obtained through photoelectric conversion of incident light, a memory array section configured to output a convolution signal indicating a result of a multiply-accumulate operation on an input signal based on the pixel signal, and a common circuit common to at least one of input and output sides of the pixel array section and the memory array section.

A signal processing method according to an embodiment of the present disclosure includes outputting a pixel signal obtained through photoelectric conversion of incident light, from a pixel array section, and outputting a convolution signal indicating a result of a multiply-accumulate operation on an input signal based on the pixel signal, from a memory array section. In this signal processing method, a common circuit common to at least one of input and output sides of the pixel array section and the memory array section is used to generate and process each of the pixel signal and the convolution signal.

### BRIEF DESCRIPTION OF DRAWINGS

FIG. 1 is a block diagram depicting a schematic configuration of an imaging device according to a first embodiment.

FIG. 2 is a diagram depicting an example of a circuit configuration of an AD converter.

FIG. 3A is a diagram depicting another example of a drive system of a horizontal operation circuit.

FIG. 3B is a diagram depicting still another example of the drive system of the horizontal operation circuit.

FIG. 4A is a circuit diagram depicting an example of a configuration of a selection circuit.

FIG. 4B is a circuit diagram depicting another example of the configuration of the selection circuit.

FIG. 5 is a diagram depicting an example of a circuit layout of an imaging device 1.

FIG. 6A is a diagram depicting an example of an equivalent circuit diagram of a pixel placed in a pixel array section.

FIG. 6B is a diagram depicting an example of an equivalent circuit diagram of a pixel placed in the pixel array section.

FIG. 6C is a diagram depicting an example of an equivalent circuit diagram of a pixel placed in the pixel array section.

FIG. 6D is a diagram depicting an example of an equivalent circuit diagram of a pixel placed in the pixel array section.

FIG. 6E is a diagram depicting an example of an equivalent circuit diagram of a pixel placed in the pixel array section.

FIG. 7 is a diagram depicting a schematic circuit configuration of a memory array section.

FIG. 8 is a block diagram depicting a schematic configuration of an imaging device according to a modified example of the first embodiment.

FIG. 9 is a block diagram depicting a schematic configuration of an imaging device according to a second embodiment.

FIG. 10 is a block diagram depicting a schematic configuration of an imaging device according to a third embodiment.

FIG. 11 is a block diagram depicting a schematic configuration of an imaging device according to a fourth embodiment.

FIG. 12 is a block diagram depicting a schematic configuration of an imaging device according to a fifth embodiment.

FIG. 13A is a circuit diagram depicting an example of a schematic configuration of a vertical drive circuit.

FIG. 13B is a circuit diagram depicting another example of the schematic configuration of the vertical drive circuit.

FIG. 14 is a block diagram depicting a schematic configuration of an imaging device according to a modified example of the fifth embodiment.

FIG. 15A is a circuit diagram depicting a schematic configuration of a vertical drive circuit according to a modified example of the fifth embodiment.

FIG. 15B is a circuit diagram depicting a schematic configuration of a vertical drive circuit according to a modified example of the fifth embodiment.

FIG. 15C is a circuit diagram depicting a schematic configuration of a vertical drive circuit according to a modified example of the fifth embodiment.

FIG. 15D is a circuit diagram depicting a schematic configuration of a vertical drive circuit according to a modified example of the fifth embodiment.

FIG. 16 is a block diagram depicting a schematic configuration of an imaging device according to a sixth embodiment.

FIG. 17 is a block diagram depicting a schematic configuration of an imaging device according to a modified example of the sixth embodiment.

FIG. 18 is a block diagram depicting a schematic configuration of an imaging device according to a seventh embodiment.

FIG. 19 is a block diagram depicting a schematic configuration of an imaging device according to a modified example of the seventh embodiment.

FIG. 20 is a diagram depicting an example of a configuration of electronic equipment according to an eighth embodiment.

FIG. 21 is a block diagram depicting an example of schematic configuration of a vehicle control system.

FIG. 22 is a diagram of assistance in explaining an example of installation positions of an outside-vehicle information detecting section and an imaging section.

### DESCRIPTION OF EMBODIMENTS

### First Embodiment

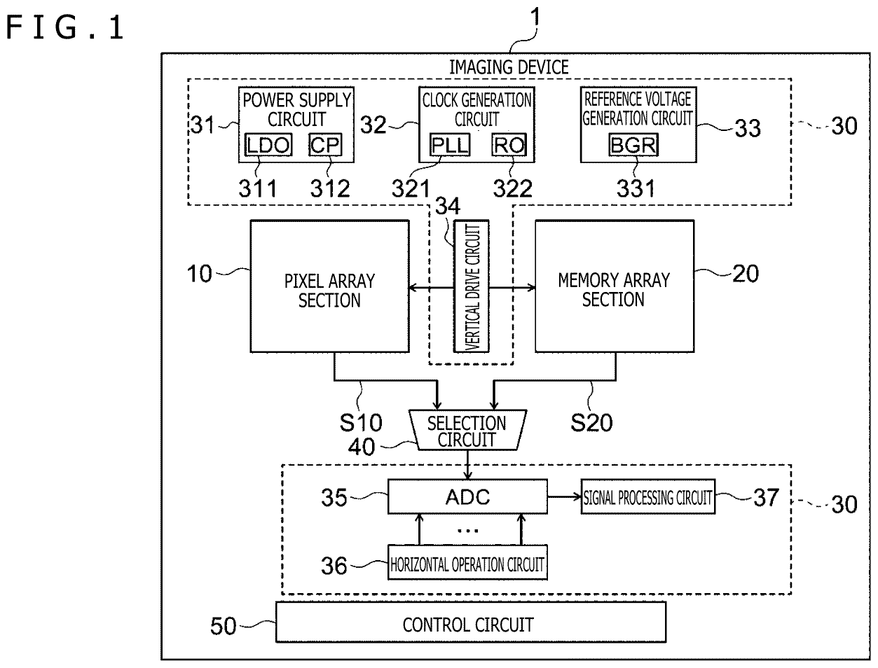

FIG. 1 is a block diagram depicting a schematic configuration of an imaging device according to a first embodiment. An imaging device 1 depicted in FIG. 1 includes a pixel array section 10, a memory array section 20, a common circuit 30, a selection circuit 40 (first selection circuit), and a control circuit 50.

The pixel array section 10 has a plurality of pixels two-dimensionally arranged. Each pixel generates a pixel signal S10 obtained through photoelectric conversion on incident light and outputs the pixel signal S10 to the selection circuit 40. A circuit configuration example of the pixel array section 10 is described later.

The memory array section 20 has a plurality of memory cells two-dimensionally arranged. The memory array section 20 outputs a convolution signal S20, which indicates a result of an analog multiply-accumulate operation using the plurality of memory cells, to the selection circuit 40. A circuit configuration example of the memory array section 20 is described later.

The common circuit 30 is a circuit common to the input and output sides of the pixel array section 10 and the memory array section 20. In the present embodiment, the common circuit 30 includes a power supply circuit 31, a clock generation circuit 32, a reference voltage generation circuit 33, a vertical drive circuit 34, an AD (Analog to Digital) converter 35, a horizontal operation circuit 36, and a signal processing circuit 37. Now, each component of the common circuit 30 is described.

The power supply circuit 31 includes a regulator (LDO) 311 and a charge pump (CP) circuit 212. Note that the power supply circuit 31 may include, in addition to the regulator 311 and the charge pump circuit 222, a circuit element configured to supply a predetermined voltage to the pixel array section 10 and the memory array section 20.

The regulator 311 is, for example, a linear regulator that can operate even with a small input and output voltage difference. Further, the charge pump circuit 222 boosts or reduces an input voltage and outputs the resultant. In the power supply circuit 31, in a case where a power supply voltage supplied from the outside of the imaging device 1 has a single or small value and the supply voltage range is wide, it is desirable to operate the charge pump circuit 222 by using an output voltage of the regulator 311. Meanwhile, in a case where a relatively constant power supply voltage is supplied from the outside, it is desirable for the charge pump circuit 222 to be directly connected to the external power supply. In this case, the regulator 311 and the charge pump circuit 222 operate independently of each other.

The clock generation circuit 32 includes a PLL (Phase-Locked Loop) circuit 321 and an oscillator (RO) 322. The PLL circuit 321 performs feedback control to set the phase of a clock signal to a set value. Further, the oscillator 322 is, for example, a ring oscillator capable of self-oscillation. In the clock generation circuit 32, the phase of the clock signal generated by the oscillator 322 is feedback-controlled by the PLL circuit 321.

The reference voltage generation circuit 33 is a circuit for generating a reference voltage within the imaging device 1 and includes, for example, a BGR (Band Gap Reference) circuit 331. The BGR circuit generates, for example, a reference voltage for the AD converter 35. Note that the reference voltage generation circuit 33 may include, in addition to the BGR circuit 331, a circuit element for setting the reference voltage, such as a DC-DC converter circuit, for example.

The vertical drive circuit 34 is a circuit configured to select a “single row,” a “part of a single row,” or a “plurality of rows” as a unit of pixel rows or memory cell rows from the pixel array section 10 and the memory array section 20. The vertical drive circuit 34 may have a circuit configuration that performs sequential scanning based on the row numbers set in advance, as in a “shift register system,” an “address decoder system,” and the like. Alternatively, the vertical drive circuit 34 may have a circuit configuration as represented by a “clock tree,” which performs global control. Moreover, the vertical drive circuit 34 may execute exposure by a global control system and execute signal readout by a system that performs sequential scanning based on row numbers, for example.

Further, in the vertical drive circuit 34, in a case where the pulse width is reduced or increased relative to clock intervals through adjustment, that is, what is generally called “digital-to-time conversion PWM drive” at 0.9 clk or 1.1 clk is performed, a system that uses delays in transistors may be used, or a voltage value may be changed for each selected row. For example, it is also possible to output an input signal (pulse width or voltage value) while outputting a signal for row selection. This input signal may be data from the signal processing circuit 37 or a frame memory (not depicted), for example.

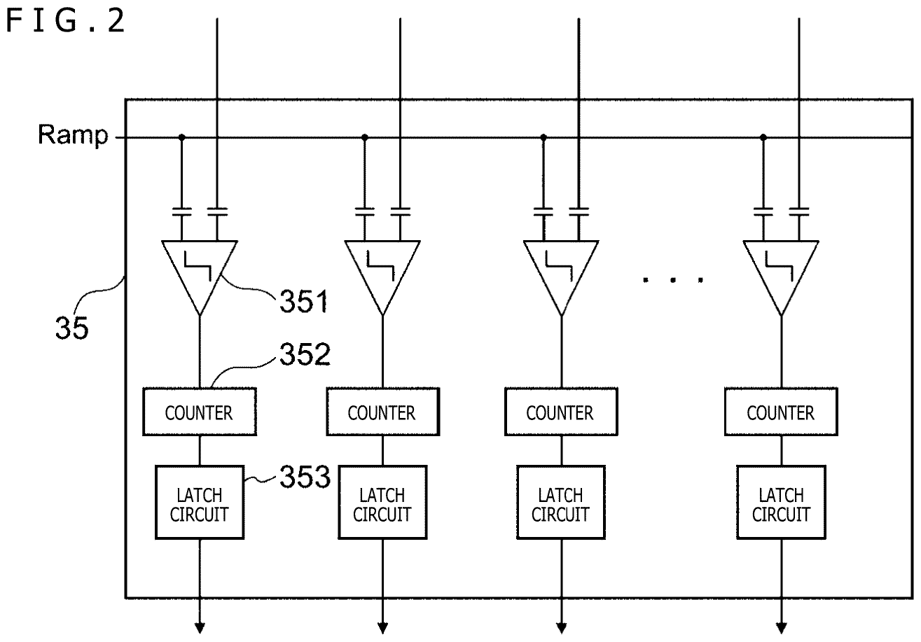

FIG. 2 is a diagram depicting an example of a circuit configuration of the AD converter 35. The AD converter 35 depicted in FIG. 2 includes a plurality of comparators 351, a plurality of counters 352, and a plurality of latch circuits 353 to convert the pixel signal S10 and the convolution signal S20, which are analog signals, into digital signals.

A non-inverting input terminal of the comparator 351 receives, as an input, among the pixel signal S10 of each pixel of the pixel array section 10 and the convolution signal S20 of each memory cell of the memory array section 20, a signal selected by the selection circuit 40. An inverting input terminal receives a ramp signal RAMP with a triangle wave as an input. Each of the comparators 351 outputs a result of comparing the pixel signal S10 or the convolution signal S20 with the ramp signal RAMP. Each of the counters 352 is connected to an output terminal of a corresponding one of the comparators 351. Each of the counters 352 counts the change time of the output level of a corresponding one of the comparators 351. Each of the latch circuits 353 holds a count result of a corresponding one of the counters 352.

Note that the AD converter 35 is not limited to the single-slope ADC depicted in FIG. 2. The AD converter 35 may be, for example, a pixel ADC configured to process the pixel signal S10 for each pixel, a column ADC configured to count the comparison time of the plurality of comparators 351 with the single counter 352, a double integration ADC including an integral circuit, a successive approximation (SAR) ADC, a ΔΣ ADC, or other ADCs. Further, the resolution of the AD converter 35 can also be appropriately selected within the range of 1 bit to 12 bits, for example.

The horizontal operation circuit 36 sequentially outputs the digital signals obtained through conversion by the AD converter 35, on the basis of the column numbers set in advance. A drive system of the horizontal operation circuit 36 may be a shift register system in which a shift register is provided for each column or a decoder system in which a decoder is provided for each column, for example. However, the drive system of the horizontal operation circuit 36 is not limited to these systems.

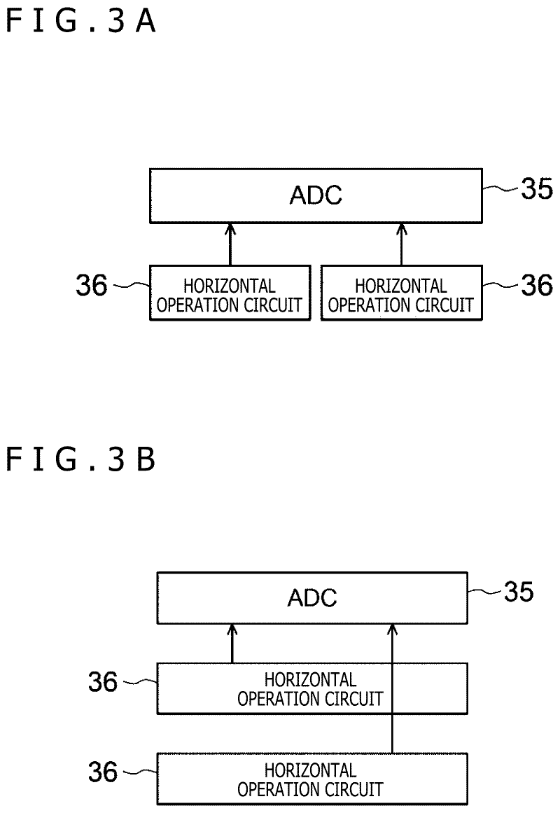

FIG. 3A is a diagram depicting another example of the drive system of the horizontal operation circuit. Further, FIG. 3B is a diagram depicting still another example of the drive system of the horizontal operation circuit.

In the example depicted in FIG. 3A, the two physically separated horizontal operation circuits 36 are provided. In this example, the first half of the scanning columns from which digital signals are output is assigned to one of the horizontal operation circuits 36, and the second half of the scanning columns is assigned to the other horizontal operation circuit 36.

On the other hand, in the example depicted in FIG. 3B, the two horizontal operation circuits 36 arranged in a nested state are provided. In this example, the scanning columns are assigned to the two respective horizontal operation circuits 36, with a shift of one or two columns, for example.

With the horizontal operation circuits depicted in FIG. 3A or FIG. 3B, the parallelism of signal processing is increased, so that the processing time can be shortened.

As depicted in FIG. 1, the signal processing circuit 37 performs four arithmetic operations, exponential and logarithmic calculations, and the like on the basis of the digital signal obtained through conversion by the AD converter 35. The signal processing circuit 37 may include a frame memory. In this case, spatially broad calculations and calculations in time-axis directions can be performed. Further, the signal processing circuit 37 may have, for DNN calculations, a calculation function using activation functions such as ReLUs (Rectified Linear Units), for example.

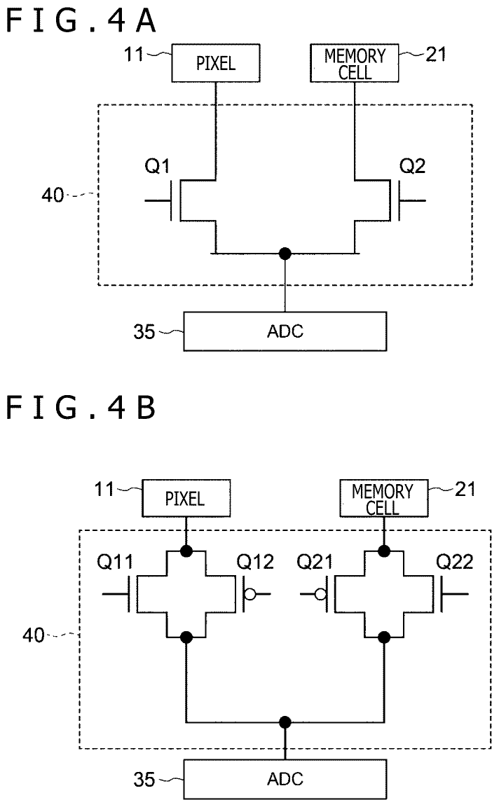

FIG. 4A is a circuit diagram depicting an example of a configuration of the selection circuit 40. Further, FIG. 4B is a circuit diagram depicting another example of the configuration of the selection circuit 40. Both the pixel signal S10 and the convolution signal S20 input to the selection circuit 40 are analog signals. Thus, the selection circuit 40 includes an analog switch. Note that a buffer circuit or a gain increasing/decreasing circuit may be provided between the pixel array section 10 (memory array section 20), the selection circuit 40, and the selection circuit 40, or between the selection circuit 40 and the AD converter 35. Specifically, an electronic circuit such as a source follower circuit, a common source circuit, a signal amplification circuit using an operational amplifier, or a switched capacitor circuit may be provided. With this electronic circuit, the signal amplitude is increased, thereby making it possible to increase the noise immunity. Further, it is possible to align the voltage ranges of the pixel array section 10 and the memory array section 20. For example, in a case where there is a voltage range difference between the pixel signal S10 and the convolution signal S20 input to the selection circuit 40, it is possible to align the voltage ranges. In a case where the above-mentioned electronic circuit is provided between the selection circuit 40 and the AD converter 35, the signal amplitude is more likely to be increased. Such an electronic circuit is typically included within the AD converter 35 as pre-processing for AD conversion by the AD converter 35. However, in the present embodiment, the position of the above-mentioned electronic circuit may be shifted from the AD converter 35 to between the pixel array section 10 (memory array section 20) and the selection circuit 40, or between the selection circuit 40 and the AD converter 35.

The selection circuit 40 depicted in FIG. 4A includes a transistor Q1 and a transistor Q2. In FIG. 4A, the transistor Q1 and the transistor Q2 are N-channel MOS transistors, but the transistor Q1 and the transistor Q2 may be P-channel MOS transistors. The transistor Q1 is connected to the pixel 11 of the pixel array section 10. Meanwhile, the transistor Q2 is connected to the memory cell 21 of the memory array section 20. A gate of each of the transistor Q1 and the transistor Q2 receives a control signal from the control circuit 50 as an input. On the basis of this control signal, each transistor enters the on state or the off state.

In a case where the selection circuit 40 selects the pixel signal S10, the transistor Q1 enters the on state, and the transistor Q2 enters the off state. In contrast, in a case where the selection circuit 40 selects the convolution signal S20, the transistor Q1 enters the off state, and the transistor Q2 enters the on state. In such a way, either one of the pixel signal S10 and the convolution signal S20 is input to the AD converter 35.

The selection circuit 40 depicted in FIG. 4B includes a transistor Q11, a transistor Q12, a transistor Q21, and a transistor Q22. The transistor Q11 and the transistor Q21 are N-channel MOS transistors, while the transistor Q12 and the transistor Q22 are P-channel MOS transistors.

The transistor Q11 and the transistor Q12 form a first CMOS switch and are connected to the pixel 11. Further, the transistor Q21 and the transistor Q22 form a second CMOS switch and are connected to the memory cell 21. A gate of each transistor receives a control signal from the control circuit 50 as an input. On the basis of this control signal, each transistor enters the on state or the off state.

In a case where the selection circuit 40 selects the pixel signal S10, the transistor Q11 and the transistor Q12 enter the on state, and the transistor Q21 and the transistor Q22 enter the off state. In contrast, in a case where the selection circuit 40 selects the convolution signal S20, the transistor Q11 and the transistor Q12 enter the off state, and the transistor Q21 and the transistor Q22 enter the on state. In such a way, either one of the pixel signal S10 and the convolution signal S20 is input to the AD converter 35.

The control circuit 50 controls the overall operation of the imaging device 1. For example, the control circuit 50 generates vertical synchronization signals, horizontal synchronization signals, and the like, on the basis of the clocks input from the clock generation circuit 32. Moreover, the control circuit 50 outputs the vertical synchronization signals to the vertical drive circuit 34 and outputs the horizontal synchronization signals to the horizontal operation circuit 36.

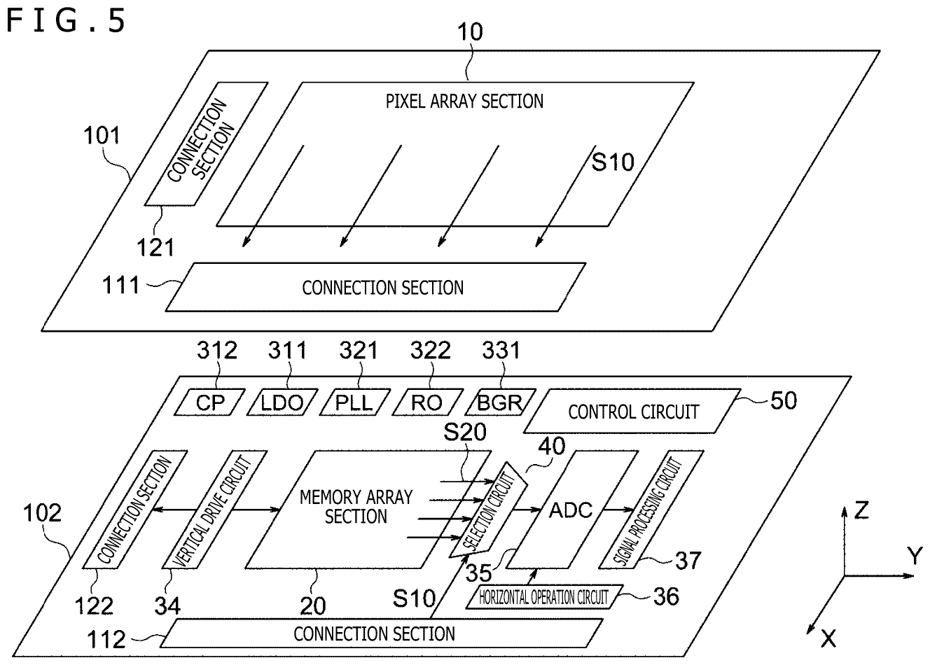

FIG. 5 is a diagram depicting an example of a circuit layout of the imaging device 1. In the layout depicted in FIG. 5, the pixel array section 10 is disposed on a first substrate 101, and the memory array section 20 is disposed on a second substrate 102. Other circuit elements, excluding the pixel array section 10, are also arranged on the second substrate 102. Note that, in FIG. 5, two directions parallel to the first substrate 101 and the second substrate 102 and orthogonal to each other are defined as an X direction and a Y direction. Further, a direction orthogonal to the X direction and the Y direction, in other words, a stacking direction of the first substrate 101 and the second substrate 102, is defined as a Z direction.

The first substrate 101 and the second substrate 102 are, for example, silicon substrates and are stacked on each other in an overlapped manner. In order to minimize the substrate area, it is unnecessary that the first substrate 101 and the second substrate 102 overlap entirely, and it is sufficient if the first substrate 101 and the second substrate 102 overlap at least in part.

The first substrate 101 has a connection section 111 and a connection section 121 provided around the pixel array section 10. Further, the second substrate 102 has a connection section 112 and a connection section 122 provided around the memory array section 20. The connection section 111 and the connection section 112 face each other in the Z direction and are electrically connected to each other by what is generally called Cu—Cu bonding, in which connection terminals provided to respective connection sections are bonded to each other, for example. Similarly, the connection section 121 and the connection section 122 can also be electrically connected to each other by Cu—Cu bonding. Through these connection sections, the pixel array section 10 is electrically connected to the circuit elements connected to the second substrate.

For example, the power supply voltage generated by the regulator 311 and the charge pump circuit 312 is supplied to the pixel array section 10 from the connection section 122 of the second substrate 102 through the connection section 121 of the first substrate 101. Further, the clock generated by the PLL circuit 321 and the oscillator 22 and the reference voltage generated by the BGR circuit 331 are also supplied to the pixel array section 10 through a path similar to that of the power supply voltage. Moreover, the control signal of the vertical drive circuit 34 is also transmitted to the pixel array section 10 through a path similar to that of the power supply voltage.

Further, the pixel signal S10 generated by the pixel array section 10 is input to the selection circuit 40 through the connection section 111 of the first substrate 101 and the connection section 112 of the second substrate 102. Subsequently, the AD converter 35 converts the pixel signal S10 into a digital pixel signal. Then, the signal processing circuit 37 processes the digital pixel signal and outputs the resultant to the vertical drive circuit 34.

Next, the vertical drive circuit 34 outputs an input signal based on the digital pixel signal to the memory array section 20. The memory array section 20 performs a multiply-accumulate operation based on the input signal and outputs the convolution signal S20 to the selection circuit 40. Subsequently, the AD converter 35 converts the convolution signal S20 into a digital convolution signal. Then, the signal processing circuit 37 processes the digital convolution signal and outputs the resultant to the outside of the imaging device 1. At this time, the signal processing circuit 37 may output results of a plurality of multiply-accumulate operations by the memory array section 20 to the outside of the imaging device 1. Further, in a case where the signal processing circuit 37 includes a frame memory, the digital pixel signals may be rearranged to be output to the vertical drive circuit 34. Further, in a case where a plurality of multiply-accumulate operations are performed, the digital convolution signals may be rearranged to be output to the vertical drive circuit 34.

In the layout depicted in FIG. 5, while the pixel signal S10 is output from the pixel array section 10 in the X direction, the convolution signal S20 is output from the memory array section 20 in the Y direction vertical to the X direction. That is, the output direction of the pixel signal S10 is different from the output direction of the convolution signal S20. Thus, the interference noise between the output wiring for the pixel signal S10 and the output wiring for the convolution signal S20 can be reduced. As a result, the quality of both the pixel signal S10 and the convolution signal S20 is improved, thereby making it possible to enhance the calculation accuracy of the DNN.

Note that, in the present embodiment, the imaging device 1 has a two-layer structure in which circuit elements are arranged in a distributed manner on two substrates stacked on each other. However, the imaging device 1 may have a single-layer structure in which all circuit elements are arranged on a single substrate. Alternatively, the imaging device 1 may have a multi-layer structure in which circuit elements are arranged in a distributed manner on three or more substrates stacked on each other. In the case of a multi-layer structure, for example, a memory such as a DRAM (Dynamic Random Memory) configured to temporarily store, for example, the data obtained by the signal processing circuit 37 processing the convolution signal S20 may be disposed on a substrate different from the first substrate 101 and the second substrate 102. Further, as the bonding method of the substrates, other than Cu—Cu bonding described above, TSV (Through Silicon Via) bonding using through electrodes, micro-bump bonding, magnetic coupling, and the like may be applied.

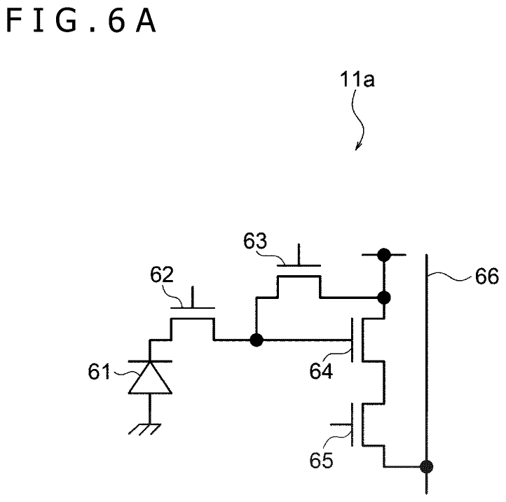

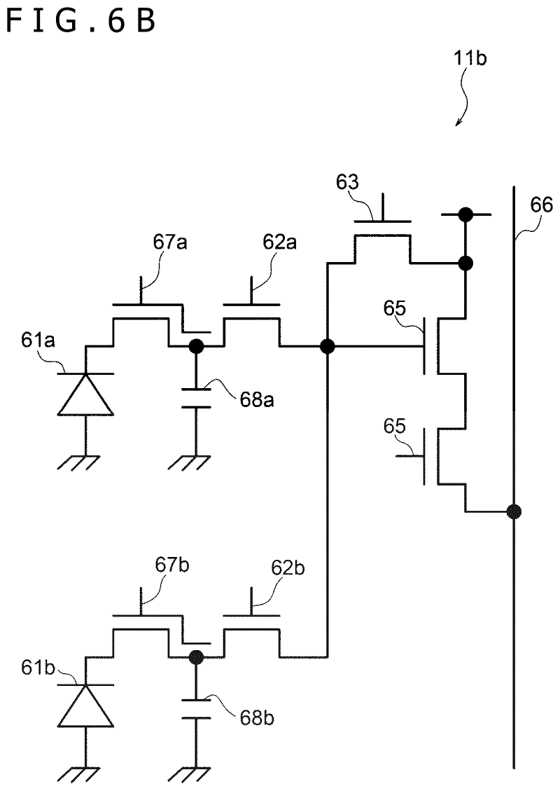

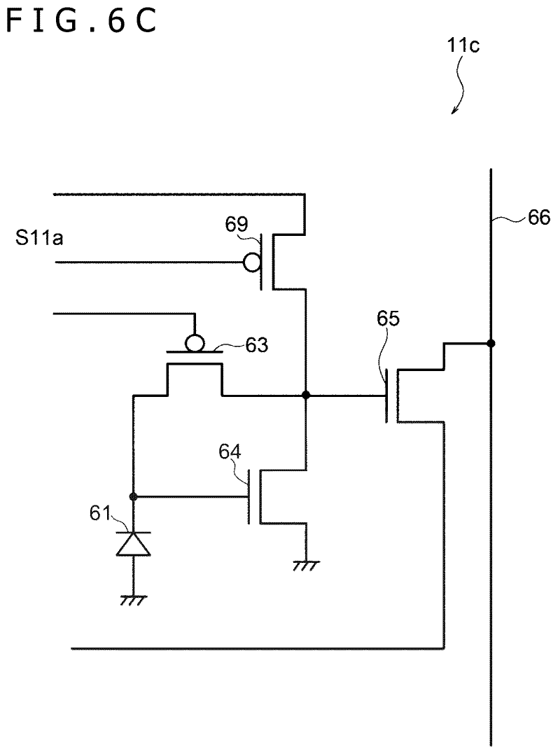

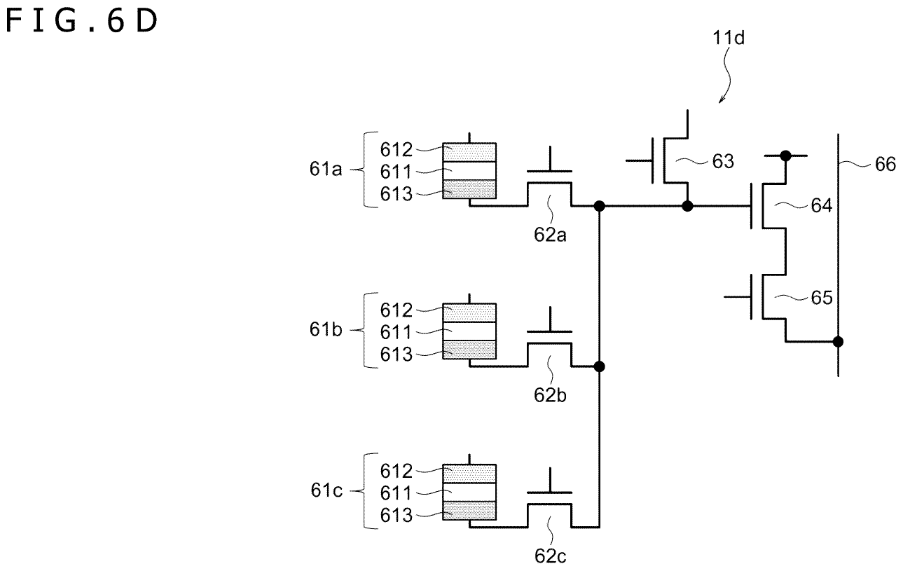

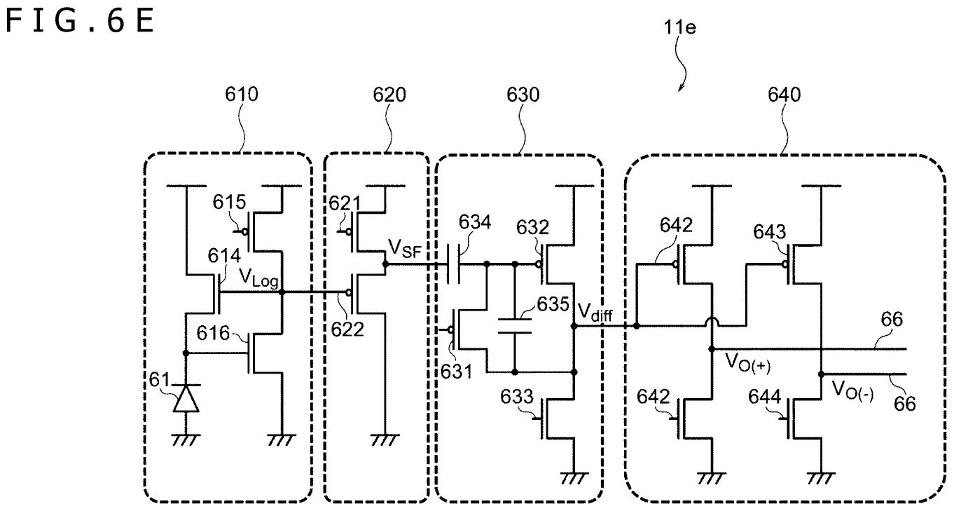

FIG. 6A to FIG. 6E are diagrams depicting examples of equivalent circuit diagrams of pixels arrayed in the pixel array section 10. Now, circuit configurations of the pixels depicted in the respective figures are described.

A pixel 11a depicted in FIG. 6A includes a photodiode 61, a transfer transistor 62, a reset transistor 63, an amplification transistor 64, and a selection transistor 65.

The photodiode 61 is a photoelectric conversion section configured to generate and accumulate charge (signal charge) corresponding to the amount of received light. An anode terminal of the photodiode 61 is grounded, and a cathode terminal thereof is connected to the transfer transistor 62.

When turned on by a transfer signal, which is one of the pixel control signals generated by the vertical drive circuit 34, the transfer transistor 62 reads out the charge from the photodiode 61 and transfers the charge to the amplification transistor 64. When turned on by a reset signal, which is one of the pixel control signals, the reset transistor 63 discharges the charge accumulated in the photodiode 61 to the power supply, thereby resetting potential of the photodiode 61.

The amplification transistor 64 outputs the pixel signal S10 corresponding to the amount of charge accumulated in the photodiode 61 to the selection transistor 65. When turned on by a selection signal, which is one of the pixel control signals, the selection transistor 65 outputs the pixel signal S10 to the signal wiring. The pixel signal S10 is transmitted to the selection circuit 40 through the signal wiring.

A pixel 11b depicted in FIG. 6B includes two photodiodes 61a and 61b. The charge generated through photoelectric conversion by the photodiode 61a is temporarily held in a memory transistor 67a and a capacitor 68a. The held charge is transferred to the amplification transistor 64 by a transfer transistor 62a. Meanwhile, the charge generated through photoelectric conversion by the photodiode 61b is temporarily held in a memory transistor 67b and a capacitor 68b. The held charge is transferred to the amplification transistor 64 by a transfer transistor 62b.

The amplification transistor 64 outputs the pixel signal S10 corresponding to the amount of charge transferred from the transfer transistor 62a or the transfer transistor 62b, to the selection transistor 65. The selection transistor 65 outputs the pixel signal S10 to the signal wiring. The pixel signal S10 is transmitted to the pixel signal processing circuit 13 through the signal wiring. Potential of each of the photodiodes 61a and 61b is reset by the reset transistor 63.

A pixel 11c depicted in FIG. 6C is an example of what is generally called a PWM (Pulse Width Modulation) pixel. In the pixel 11c, a slope signal S11a, which is one of the pixel control signals, is input to a gate of a P-channel MOS transistor 69. The MOS transistor 69 is connected in series to the amplification transistor 64. The selection transistor 65 outputs, to the signal wiring, the PWM pixel signal S10 indicating a result of a comparison between the output of the MOS transistor 69 and the output of the amplification transistor 64. The pixel signal S10 is transmitted to the selection circuit 40 through the signal wiring.

A pixel 11d depicted in FIG. 6D includes photodiodes 61a to 61c each including a photoelectric conversion film 611, a transparent electrode 612, and a bottom electrode 613. The photoelectric conversion film 611 is an organic photoelectric conversion film or an inorganic photoelectric conversion film. The transparent electrode 612 is disposed on the upper surface of the photoelectric conversion film 611. The bottom electrode 613 is disposed on the upper surface of the photoelectric conversion film 611. That is, the transparent electrode 612 is sandwiched between the transparent electrode 612 and the bottom electrode 613. For example, the photoelectric conversion film 611 controls a voltage of the transparent electrode 612, thereby achieving a global shutter.

The charge obtained through photoelectric conversion by the photoelectric conversion films 611 of the photodiode 61a to the photodiode 61c is transferred to the amplification transistor 64 by the transfer transistor 62a to a transfer transistor 62c. The amplification transistor 64 outputs the pixel signal S10 corresponding to the amount of charge accumulated in the photodiode 61 to the selection transistor 65. The selection transistor 65 outputs the pixel signal S10 to the signal wiring. The pixel signal S10 is transmitted to the pixel signal processing circuit 13 through the signal wiring. Potential of each of the photodiodes is reset by the reset transistor 63.

A pixel 11e depicted in FIG. 6E is an example of a DVS (Dynamic Vision Sensor) pixel configured to output changes in brightness. The pixel 11e includes a logarithmic transformation circuit 610, a buffer circuit 620, a subtraction circuit 630, and a quantization circuit 640.

The logarithmic transformation circuit 610 includes the photodiode 61, an N-channel MOS transistor 614, a P-channel MOS transistor 615, and an N-channel MOS transistor 616. The photodiode 61 and the MOS transistor 614 are connected in series. Further, the MOS transistor 615 and the MOS transistor 616 are also connected in series. Moreover, a gate of the MOS transistor 614 is connected to a drain of the MOS transistor 615 and a drain of the MOS transistor 616. In the logarithmic transformation circuit 610, the charge obtained through photoelectric conversion by the photodiode 61 is transformed into a logarithmic output voltage Vlog.

The buffer circuit 620 includes a P-channel MOS transistor 621 and a P-channel MOS transistor 622. The MOS transistor 621 is connected in series to the MOS transistor 622. The buffer circuit 620 outputs a source follower voltage VSF obtained by performing an impedance transformation on the voltage Vlog input to a gate of the MOS transistor 622.

The subtraction circuit 630 includes a P-channel MOS transistor 631, a P-channel MOS transistor 632, an N-channel MOS transistor 633, a capacitor 534, and a capacitor 535. The MOS transistor 632 is connected in series to the MOS transistor 633. A gate of the MOS transistor 632 is connected to the capacitor 534. The MOS transistor 631 is connected in parallel to the capacitor 535 between the gate and a drain of the MOS transistor 632. The subtraction circuit 630 outputs a differential voltage Vdiff with respect to the previous signal.

The quantization circuit 640 includes a P-channel MOS transistor 641, an N-channel MOS transistor 642, a P-channel MOS transistor 643, and an N-channel MOS transistor 644. The MOS transistor 641 and the MOS transistor 642 are connected in series. Further, the MOS transistor 643 and the MOS transistor 644 are also connected in series. In the quantization circuit 640, the differential voltage Vdiff input to a gate of each of the MOS transistor 641 and the MOS transistor 643 is compared with two threshold values. After that, comparison results (VO (+) and VO (−)) are transmitted to the pixel signal processing circuit 13 through the signal wiring, as the pixel signal S10. The pixel signal processing circuit 13 determines “+1,” “0,” or “−1” on the basis of the pixel signal S10.

The pixels arrayed in the pixel array section 10 are not limited to the pixel 11a to the pixel 11e depicted in FIG. 6A to FIG. 6E. For example, in the pixel array section 10, what are generally called convolution pixels in which the pixel signals S10 of the respective pixels are added may be arrayed. Further, in the pixel array section 10, other than the CMOS image sensor and DVS described above, a polarization sensor or a multispectral sensor may be placed.

The polarization sensor further includes a diffractive element configured to polarize the light entering the photodiode 61. Meanwhile, the multispectral sensor further includes a color filter configured to color-separate the light entering the photodiode 61.

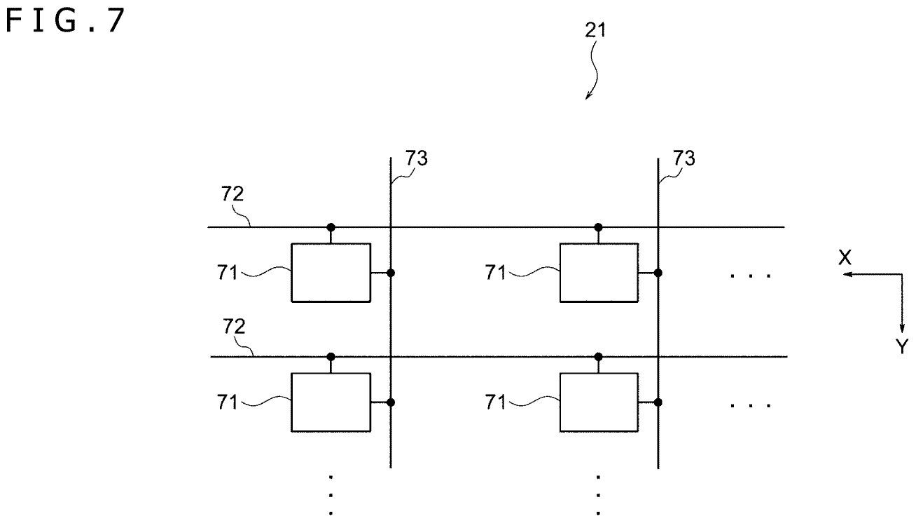

FIG. 7 is a diagram depicting a schematic circuit configuration of the memory array section 20. As depicted in FIG. 7, the memory array section 20 has a plurality of memory cells 71 two-dimensionally arranged. Each of the memory cells 71 is disposed near the intersection of a signal wiring line 72 and a signal wiring line 73. Note that the memory cells 71 may be three-dimensionally arranged. In this case, the plurality of memory cells 71 are arranged in the X direction, the Y direction, and the Z direction.

As the memory cell 71, for example, a resistive random access memory (ReRAM), a phase change memory (PCM), a magnetoresistive random access memory (MRAM: Magneto resistive Random Memory), a ferroelectric random access memory (FeRAM), or the like can be applied. Further, the memory cell 71 may also be an SRAM (Static Random Access Memory) or a non-volatile memory.

The memory cell 71 holds a memory value (for example, +1, −1, or 0.5). The memory array section 20 multiplies the memory value of each of the memory cells 71 with a signal value of the memory cell control signal input from the vertical drive circuit 34 through the signal wiring line 72 as an input signal. Subsequently, the memory array section 20 sequentially adds multiplication results in units of rows or columns through the signal wiring line 73. At this time, the input signal can be input to all the signal wiring lines 72 all at once, and in a case where the AD converter 35 is a column ADC, it is also possible to read out the convolution signals S20 from all the signal wiring lines 73 all at once.

In the imaging device 1 described above, a configuration of the drive circuit of the pixel array section 10 and a configuration of the drive circuit of the memory array section 20 are very similar. In addition, the output signal of the pixel array section 10 and the output signal of the memory array section 20 are both analog signals, and further, configurations of the processing circuits configured to digitally process these analog signals, for example, are also very similar.

Thus, in the present embodiment, the peripheral circuits including the drive circuit disposed on the input side of the pixel array section 10 and the memory array section 20, the processing circuit disposed on the output side thereof, and the like are common to the pixel array section 10 and the memory array section 20. With this, the ratio of the area occupied by the peripheral circuits to the entire area of the imaging device 1 can be reduced. As a result, it is possible to reduce the imaging device 1 in size.

### First Modified Example

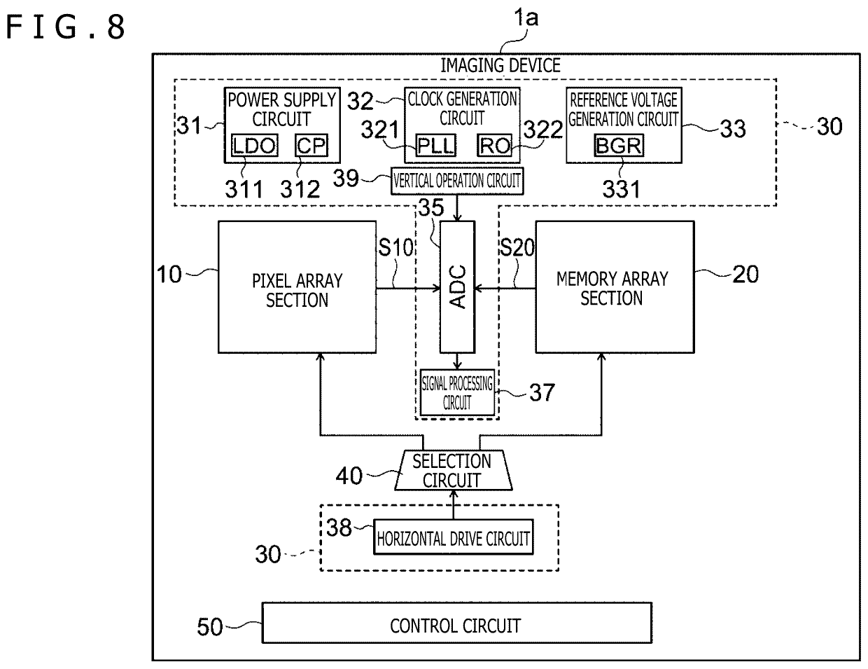

FIG. 8 is a block diagram depicting a schematic configuration of an imaging device according to a modified example of the first embodiment. In the present modified example, components similar to those of the first embodiment are denoted by the same reference signs, and the detailed descriptions thereof are omitted.

An imaging device 1a depicted in FIG. 8 has a configuration in which the vertical drive circuit 34 and the horizontal operation circuit 36 described in the first embodiment are interchanged. Specifically, a horizontal drive circuit 38 is provided in place of the vertical drive circuit 34, and a vertical operation circuit 39 is provided in place of the horizontal operation circuit 36.

The horizontal drive circuit 38 selects pixel columns or memory cell columns from the pixel array section 10 and the memory array section 20. The horizontal drive circuit 38 is connected to each of the pixel array section 10 and the memory array section 20 through the selection circuit 40. In a case where the pixel array section 10 is driven, the selection circuit 40 transmits the pixel control signal generated by the horizontal drive circuit 38 to the pixel array section 10. Meanwhile, in a case where the memory array section 20 is driven, the selection circuit 40 transmits the memory cell control signal generated by the horizontal drive circuit 38 to the pixel array section 10.

The pixel signal S10 generated by the pixel array section 10 and the convolution signal S20 generated by the memory array section 20 are converted into digital signals by the AD converter 35. The digital signals are sequentially output to the signal processing circuit 37 by the vertical operation circuit 39 on the basis of the row numbers set in advance.

In the present modified example described above, the horizontal drive circuit 38 and the vertical operation circuit 39 are common to the pixel array section 10 and the memory array section 20. Thus, as in the first embodiment, it is possible to reduce the imaging device 1a in size.

### Second Embodiment

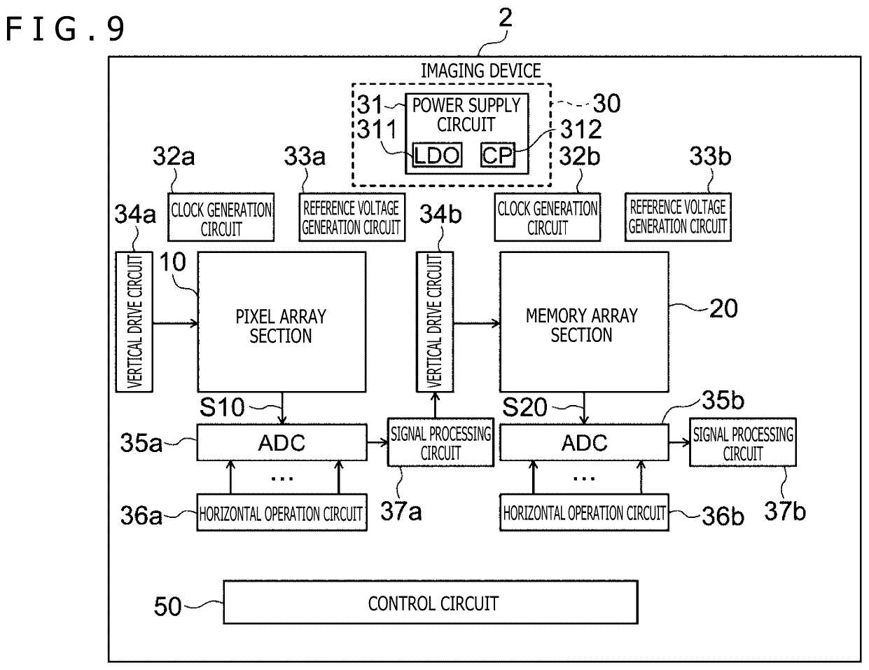

FIG. 9 is a block diagram depicting a schematic configuration of an imaging device according to a second embodiment. In the present embodiment, components similar to those of the first embodiment are denoted by the same reference signs, and the detailed descriptions thereof are omitted. The differences from the first embodiment are mainly described.

In an imaging device 2 according to the present embodiment, as depicted in FIG. 9, the power supply circuit 31 is the common circuit 30. Note that the power supply circuit 31 depicted in FIG. 9 includes the single regulator 311 and the single charge pump circuit 312, but there is no particular limitation on the number of the regulators 311 and the number of the charge pump circuits 312. In a case where the power supply circuit 31 includes the plurality of regulators 311 and the plurality of charge pump circuits 212, all or some of the regulators 311 and the charge pump circuits 312 may be common to the pixel array section 10 and the memory array section 20.

In the present embodiment, since the common circuit 30 is the power supply circuit 31 as described above, a clock generation circuit 32a, a reference voltage generation circuit 33a, and a vertical drive circuit 34a are arranged on the input side of the pixel array section 10 to allow the pixel array section 10 to generate the pixel signal S10. Further, an AD converter 35a, a horizontal operation circuit 36a, and a signal processing circuit 37a are arranged on the output side of the pixel array section 10 to process the pixel signal S10.

Further, a clock generation circuit 32b, a reference voltage generation circuit 33b, and a vertical drive circuit 34b are arranged on the input side of the memory array section 20 to allow the memory array section 20 to generate the convolution signal S20. Further, an AD converter 35b, a horizontal operation circuit 36b, and a signal processing circuit 37b are arranged on the output side of the memory array section 20 to process the convolution signal S20.

According to the present embodiment described above, the power supply circuit 31 is common to the pixel array section 10 and the memory array section 20. Thus, it is possible to make the imaging device 2 according to the present embodiment smaller than an imaging device in which the power supply circuit is provided for each of the pixel array section 10 and the memory array section 20.

Further, by using the power supply circuit in common, the number of power supply systems is reduced, and hence the design is simplified. Thus, it is possible to significantly reduce the cost required for design verification. Thus, according to the present embodiment, not only that the area of the power supply circuit can be reduced, but also that the ease of design can be improved.

### Third Embodiment

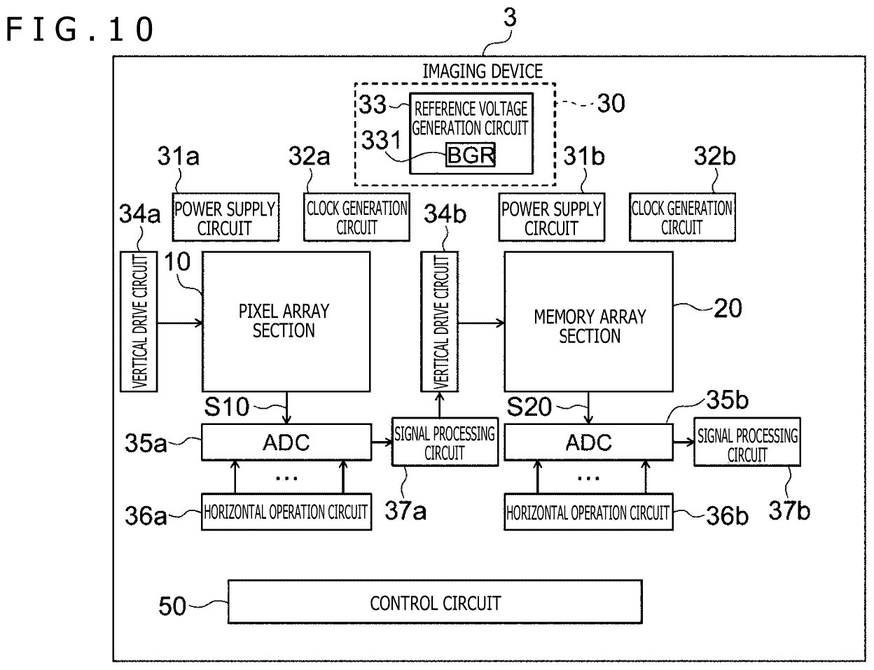

FIG. 10 is a block diagram depicting a schematic configuration of an imaging device according to a third embodiment. Also in the present embodiment, components similar to those of the first embodiment are denoted by the same reference signs, and the detailed descriptions thereof are omitted. The differences from the first embodiment are mainly described.

In an imaging device 3 according to the present embodiment, as depicted in FIG. 10, the reference voltage generation circuit 33 is the common circuit 30. Note that the reference voltage generation circuit 33 depicted in FIG. 10 includes the single BGR circuit 331, but there is no particular limitation on the number of the BGR circuits 331. In a case where the reference voltage generation circuit 33 includes the plurality of BGR circuits 331, all or some of the BGR circuits 331 may be common to the pixel array section 10 and the memory array section 20.

In the present embodiment, since the common circuit 30 is the reference voltage generation circuit 33 as described above, a power supply circuit 31a, the clock generation circuit 32a, and the vertical drive circuit 34a are arranged on the input side of the pixel array section 10 to allow the pixel array section 10 to generate the pixel signal S10. Further, the AD converter 35a, the horizontal operation circuit 36a, and the signal processing circuit 37a are arranged on the output side of the pixel array section 10 to process the pixel signal S10.

Further, a power supply circuit 31b, the clock generation circuit 32b, and the vertical drive circuit 34b are arranged on the input side of the memory array section 20 to allow the memory array section 20 to generate the convolution signal S20. Further, the AD converter 35b, the horizontal operation circuit 36b, and the signal processing circuit 37b are arranged on the output side of the memory array section 20 to process the convolution signal S20.

According to the present embodiment described above, the reference voltage generation circuit 33 is common to the pixel array section 10 and the memory array section 20. Thus, it is possible to make the imaging device 3 according to the present embodiment smaller than an imaging device in which the reference voltage generation circuit is provided for each of the pixel array section 10 and the memory array section 20.

### Fourth Embodiment

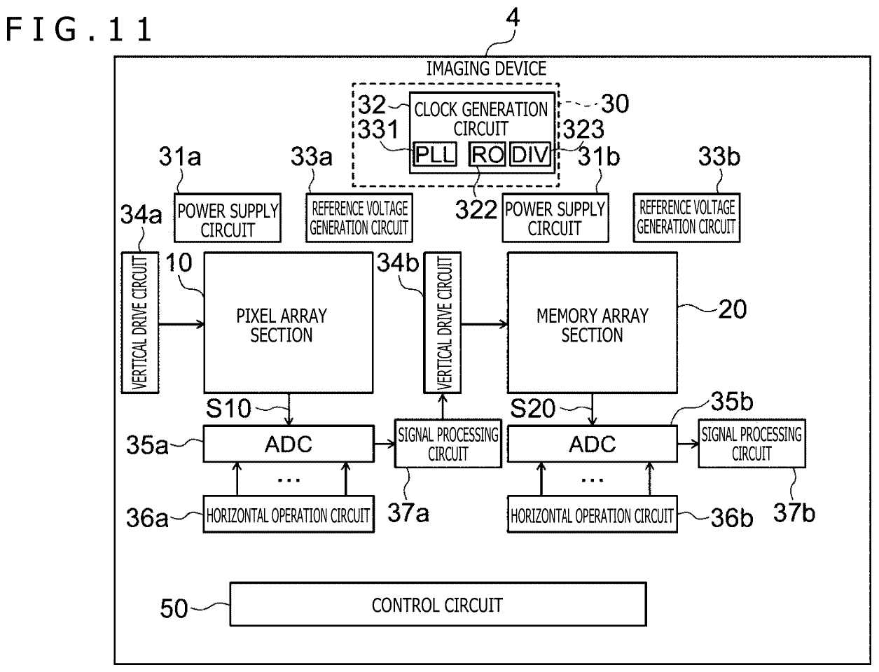

FIG. 11 is a block diagram depicting a schematic configuration of an imaging device according to a fourth embodiment. Also in the present embodiment, components similar to those of the first embodiment are denoted by the same reference signs, and the detailed descriptions thereof are omitted. The differences from the first embodiment are mainly described.

In an imaging device 4 according to the present embodiment, as depicted in FIG. 11, the clock generation circuit 32 is the common circuit 30. Note that the clock generation circuit 32 may include, in addition to the PLL circuit 321 and the oscillator 322, a frequency divider (DIV) 323 for setting the operating frequencies of the pixel array section 10 and the memory array section 20.

In a case where the clock generation circuit 32 generates clocks, the frequency divider 323 adjusts the frequency division ratio, thereby allowing clocks with different operating frequencies to be set to the pixel array section 10 and the memory array section 20. In this case, even when the pixel array section 10 and the memory array section 20 have different specifications, clocks suitable for the specifications of the respective array sections can be set. Further, since the PLL circuit 321 requires a reference clock, a clock shaped outside the imaging device 4 is basically input to the PLL circuit 321. Thus, in a case where the external supply is stopped, such as during low-power operation, it is preferable to use an internal oscillator instead of the PLL 321.

In the present embodiment, since the common circuit 30 is the clock generation circuit 32 as described above, the power supply circuit 31a, the reference voltage generation circuit 33a, and the vertical drive circuit 34a are arranged on the input side of the pixel array section 10 to allow the pixel array section 10 to generate the pixel signal S10. Further, the AD converter 35a, the horizontal operation circuit 36a, and the signal processing circuit 37a are arranged on the output side of the pixel array section 10 to process the pixel signal S10.

Further, the power supply circuit 31b, the reference voltage generation circuit 33b, and the vertical drive circuit 34b are arranged on the input side of the memory array section 20 to allow the memory array section 20 to generate the convolution signal S20. Further, the AD converter 35b, the horizontal operation circuit 36b, and the signal processing circuit 37b are arranged on the output side of the memory array section 20 to process the convolution signal S20.

According to the present embodiment described above, the clock generation circuit 32 is common to the pixel array section 10 and the memory array section 20. Thus, it is possible to make the imaging device 4 according to the present embodiment smaller than an imaging device in which the clock generation circuit is provided for each of the pixel array section 10 and the memory array section 20.

Further, when the clock generation circuit is provided for each of the pixel array section 10 and the memory array section 20, the asynchronous design of a plurality of clock systems is required, thereby increasing the degree of difficulty of design. Thus, by using the clock generation circuit in common to reduce the number of clock systems as in the present embodiment, not only that the circuit area can be reduced, but also that the degree of difficulty of design can be reduced.

### Fifth Embodiment

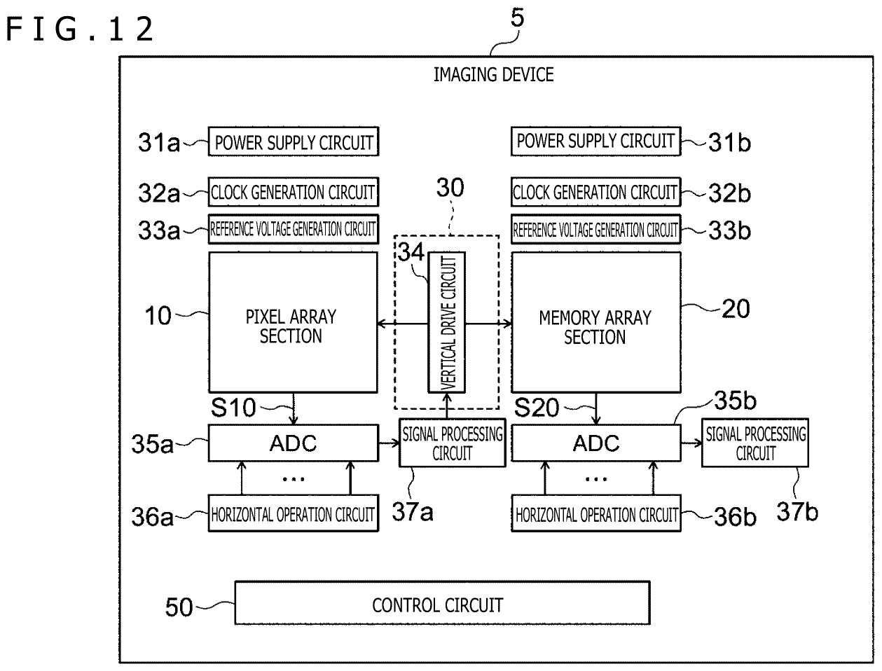

FIG. 12 is a block diagram depicting a schematic configuration of an imaging device according to a fifth embodiment. Also in the present embodiment, components similar to those of the first embodiment are denoted by the same reference signs, and the detailed descriptions thereof are omitted. The differences from the first embodiment are mainly described.

In an imaging device 5 according to the present embodiment, as depicted in FIG. 12, the vertical drive circuit 34 is the common circuit 30. Thus, the power supply circuit 31a, the clock generation circuit 32, and the reference voltage generation circuit 33a are arranged on the input side of the pixel array section 10 to allow the pixel array section 10 to generate the pixel signal S10. Further, the AD converter 35a, the horizontal operation circuit 36a, and the signal processing circuit 37a are arranged on the output side of the pixel array section 10 to process the pixel signal S10.

Further, the power supply circuit 31b, the clock generation circuit 32b, and the reference voltage generation circuit 33b are arranged on the input side of the memory array section 20 to allow the memory array section 20 to generate the convolution signal S20. Further, the AD converter 35b, the horizontal operation circuit 36b, and the signal processing circuit 37b are arranged on the output side of the memory array section 20 to process the convolution signal S20.

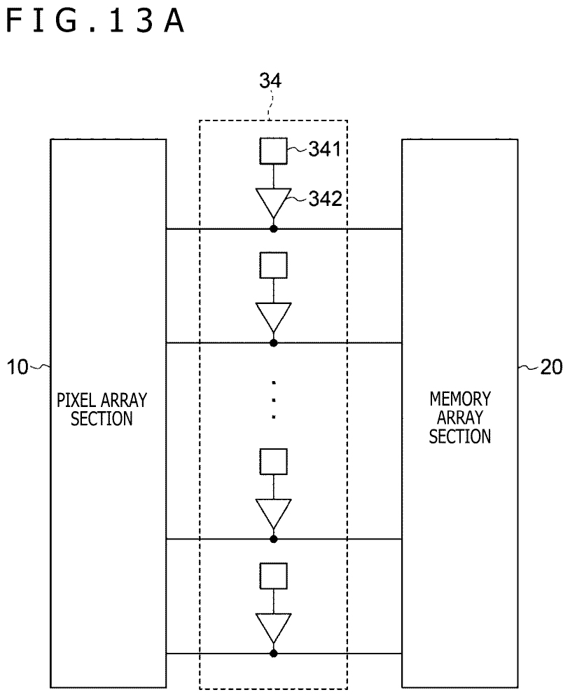

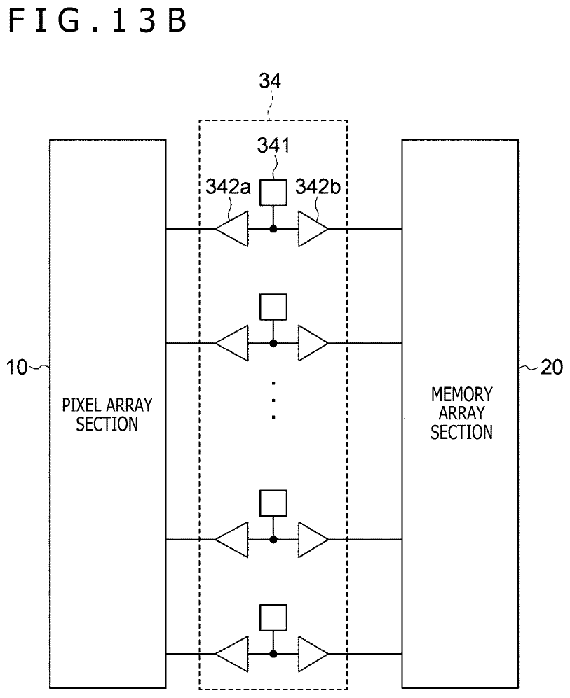

FIG. 13A is a circuit diagram depicting an example of a schematic configuration of the vertical drive circuit 34. The vertical drive circuit 34 depicted in FIG. 13A includes a plurality of registers 341 and a plurality of voltage adjustment sections 342. The voltage adjustment section 342 is disposed between the register 341 and the pixel array section 10 or the memory array section 20 and adjusts a voltage value of the output signal of the register 341. In FIG. 13A, the voltage adjustment section 342 is a buffer circuit including an operational amplifier, but the voltage adjustment section 342 may be a CMOS inverter circuit in which an N-channel MOS transistor is connected in series to a P-channel MOS transistor.

FIG. 13B is a circuit diagram depicting another example of a schematic configuration of the vertical drive circuit 34. The vertical drive circuit 34 depicted in FIG. 13B includes the plurality of registers 341, a plurality of first voltage adjustment sections 342a, and a plurality of second voltage adjustment sections 342b (second voltage adjustment sections). Each of the first voltage adjustment sections 342a is disposed between a corresponding one of the registers 341 and the pixel array section 10. Meanwhile, each of the second voltage adjustment sections 342b is disposed between a corresponding one of the registers 341 and the memory array section 20. The vertical drive circuit 34 depicted in FIG. 13B includes separate voltage adjustment sections for the pixel array section 10 and the memory array section 20. Thus, signal voltages input to the pixel array section 10 and the memory array section 20 can be individually adjusted.

According to the present embodiment described above, the vertical drive circuit 34 is common to the pixel array section 10 and the memory array section 20. Thus, it is possible to make the imaging device 5 according to the present embodiment smaller than an imaging device in which the vertical drive circuit is provided for each of the pixel array section 10 and the memory array section 20. In particular, in a case where the vertical drive circuit is of an address selection type, the advantage of using the vertical drive circuit in common is significant, as there are many common components.

### Second Modified Example

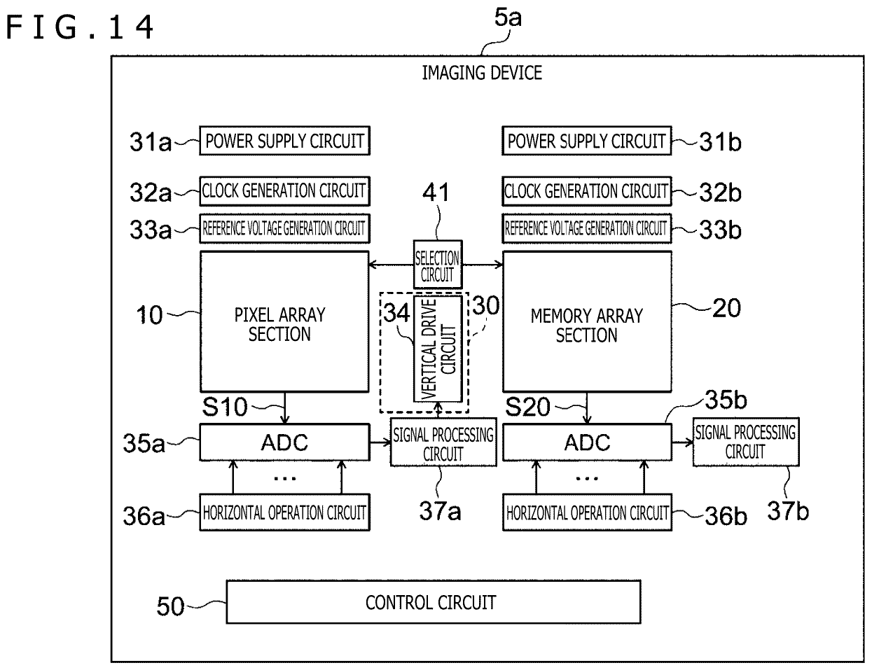

FIG. 14 is a block diagram depicting a schematic configuration of an imaging device according to a modified example of the fifth embodiment. In the present modified example, components similar to those of the fifth embodiment are denoted by the same reference signs, and the detailed descriptions thereof are omitted.

An imaging device 5a depicted in FIG. 14 further includes a selection circuit 41 (second selection circuit), in addition to the components of the imaging device 5 according to the fifth embodiment described above. The selection circuit 41 switches the connection destination of the vertical drive circuit 34 to the pixel array section 10 or the memory array section 20. The selection circuit 41 has a circuit configuration similar to that of the selection circuit 40 depicted in FIG. 4A or FIG. 4B. That is, the selection circuit 41 includes the transistors Q1 and Q2 depicted in FIG. 4A, or the transistors Q11, Q12, Q21, and Q22 depicted in FIG. 4B.

In the selection circuit 41, for example, when the transistor Q1 or the transistors Q11 and 012 enter the on state and the transistor Q2 or the transistors Q21 and Q22 enter the off state, the vertical drive circuit 34 is connected to the pixel array section 10 through the selection circuit 41. With this, the pixel control signal generated by the vertical drive circuit 34 is input to each of the pixels 11 of the pixel array section 10. Each of the pixels 11 generates the pixel signal S10 on the basis of the pixel control signal and outputs the pixel signal S10 to the AD converter 35a.

After that, in the selection circuit 41, when the transistor Q1 or the transistors Q11 and Q12 enter the off state and the transistor Q2 or the transistors Q21 and Q22 enter the on state, the vertical drive circuit 34 is connected to the memory array section 20 through the selection circuit 41. With this, the input signal generated by the vertical drive circuit 34 is input to each of the memory cells 21 of the memory array section 20. Each of the memory cells 21 generates the convolution signal S20 and outputs the convolution signal S20 to the AD converter 35b.

According to the present modified example described above, the selection circuit 41 switches the connection destination of the vertical drive circuit 34 to the pixel array section 10 or the memory array section 20, depending on imaging operations and multiply-accumulate operations. Thus, it is possible to appropriately perform the signal output of the vertical drive circuit 34 on the basis of the contents of the operation.

### Third Modified Example

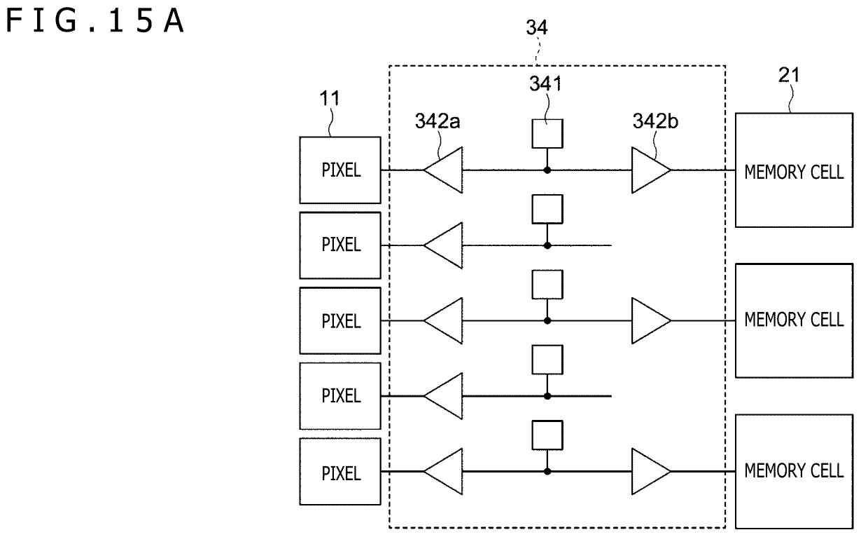

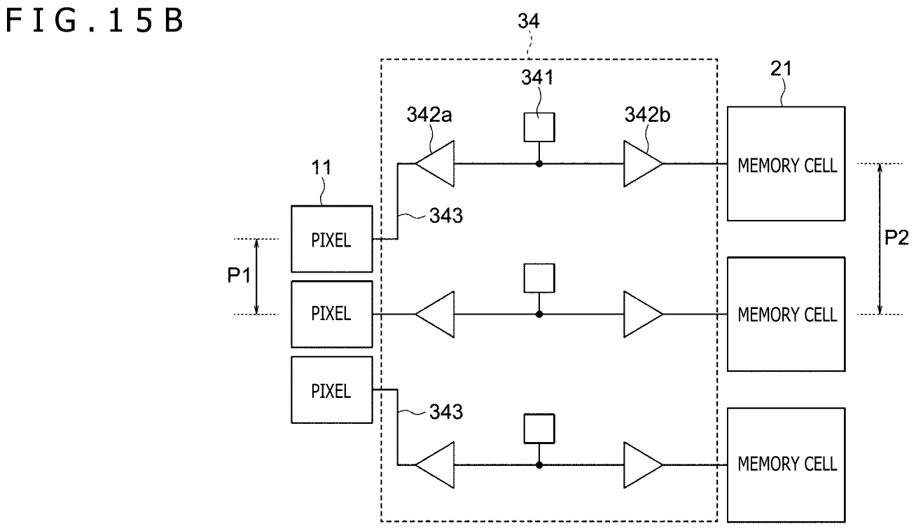

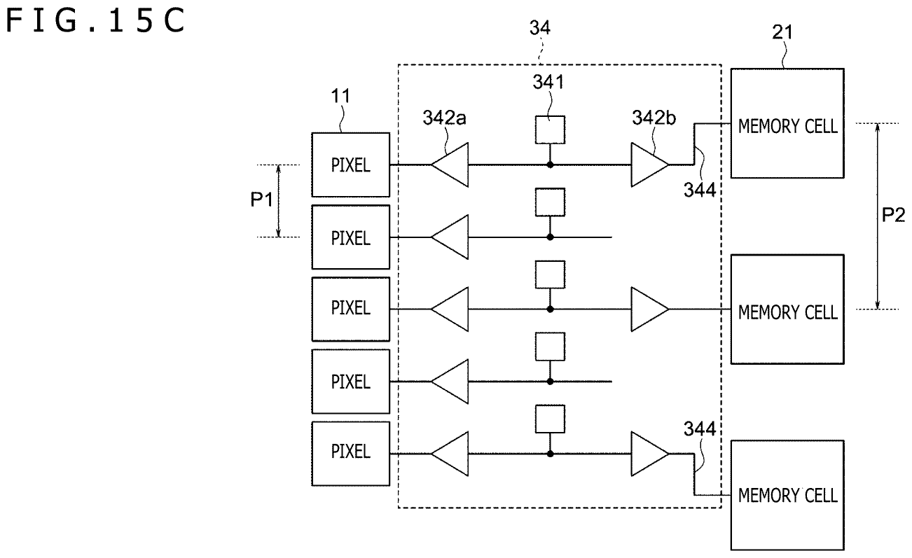

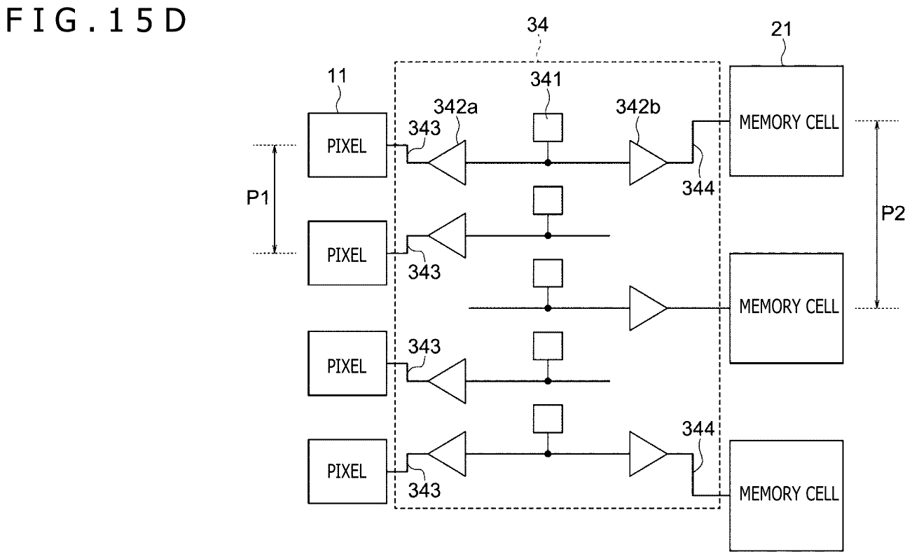

FIG. 15A to FIG. 15D are circuit diagrams depicting schematic configurations of the vertical drive circuit 34 according to modified examples of the fifth embodiment. The vertical drive circuit 34 depicted in each of FIG. 15A to FIG. 15D includes the registers 341, the plurality of first voltage adjustment sections 342a, and the plurality of second voltage adjustment sections 342b.

In the modified example depicted in FIG. 15A, the number of rows of the pixels 11 is different from the number of rows of the memory cells 21. Thus, the number of the first voltage adjustment sections 342a connected to the pixels 11 is also different from the number of the second voltage adjustment sections 342b connected to the memory cells 21. Specifically, since the number of rows of the pixels 11 is greater than the number of rows of the memory cells 21, the number of the first voltage adjustment sections 342a is greater than the number of the second voltage adjustment sections 342b. In this vertical drive circuit 34, the layout of the voltage adjustment sections is designed to match the greater one of the number of rows of the pixels 11 and the number of rows of the memory cells 21, and the voltage adjustment sections are formed at intervals for the pixels 11 or the memory cells 21 with the fewer rows. According to the present modified example, the vertical drive circuit 34 can be common to the pixel 11 and the memory cell 21 even when there is a difference in the number of rows between the pixel 11 and the memory cell 21.

In the modified example depicted in FIG. 15B, the number of rows of the pixels 11 is the same as the number of rows of the memory cells 21. Meanwhile, a center pitch P1 between the pixels 11 is different from a center pitch P2 between the memory cells 21. That is, the size of the pixels 11 is different from the size of the memory cells 21. Thus, some of the plurality of signal wiring lines 343 configured to connect the pixels 11 to the first voltage adjustment sections 342a are bent toward the inner side of the vertical drive circuit 34, as depicted in FIG. 15B. Further, a wiring pitch from the register 341 to the first voltage adjustment section 342a is designed to match the center pitch P2 of the memory cells 21 larger than the center pitch P1 of the pixels 11. According to the present modified example, the vertical drive circuit 34 can be common to the pixel 11 and the memory cell 21 even when there is a difference in center pitch between the pixel 11 and the memory cell 21.

In the modified example depicted in FIG. 15C, the number of rows of the pixels 11 is different from the number of rows of the memory cells 21. Moreover, the center pitch P1 between the pixels 11 is also different from the center pitch P2 between the memory cells 21. Thus, in this modified example, some of the plurality of signal wiring lines 344 configured to connect the memory cells 21 to the second voltage adjustment sections 342b are bent toward the outer side of the vertical drive circuit 34, as depicted in FIG. 15C. Further, a wiring pitch from the register 341 to the second voltage adjustment section 342b is designed to match the center pitch P1 of the pixels 11 smaller than the center pitch P2 of the memory cells 21. Further, the second voltage adjustment sections 342b are arranged at intervals such that the number of the second voltage adjustment sections 342b matches the number of rows of the memory cells 21. According to the present modified example, the vertical drive circuit 34 can be common to the pixel 11 and the memory cell 21 even when there are differences in the number of rows and center pitch between the pixel 11 and the memory cell 21.

In the modified example depicted in FIG. 15D, as in FIG. 15C, the number of rows of the pixels 11 is different from the number of rows of the memory cells 21, and the center pitch P1 between the pixels 11 is also different from the center pitch P2 between the memory cells 21. Thus, in this modified example, the signal wiring lines 343 configured to connect the pixels 11 to the first voltage adjustment sections 342a are bent, and the signal wiring lines 344 configured to connect the memory cells 21 to the second voltage adjustment sections 342b are also bent. Moreover, to make the number of the voltage adjustment sections 342 match the number of rows of the pixels 11 and make the number of the second voltage adjustment sections 342b match the number of rows of the memory cells 21, the respective voltage adjustment sections are arranged at intervals. Also in the present modified example, the vertical drive circuit 34 can be common to the pixel 11 and the memory cell 21 in a configuration in which there are differences in the number of rows and center pitch between the pixel 11 and the memory cell 21.

### Sixth Embodiment

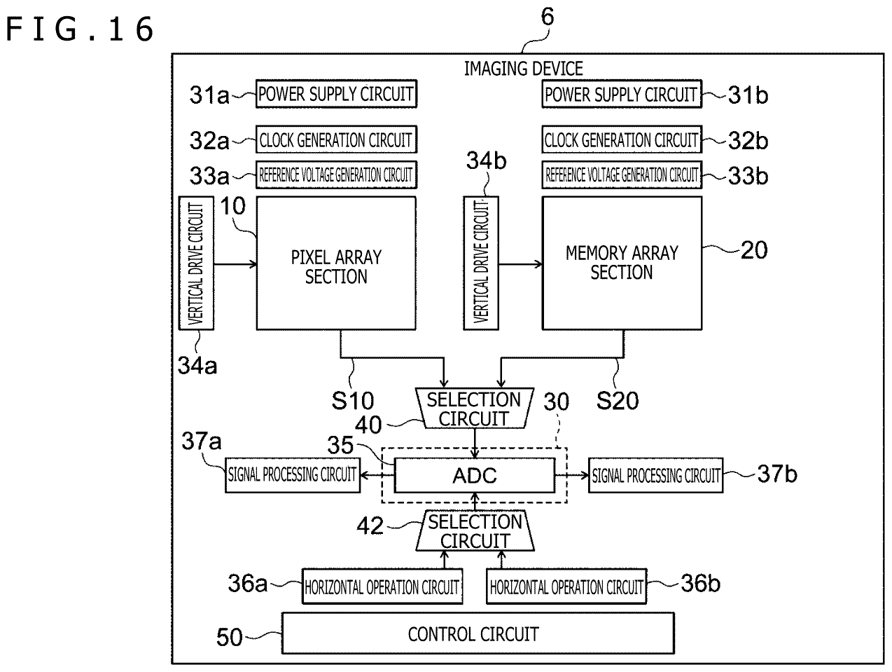

FIG. 16 is a block diagram depicting a schematic configuration of an imaging device according to a sixth embodiment. Also in the present embodiment, components similar to those of the first embodiment are denoted by the same reference signs, and the detailed descriptions thereof are omitted. The differences from the first embodiment are mainly described.

In an imaging device 6 according to the present embodiment, as depicted in FIG. 16, the AD converter 35 is the common circuit 30. Further, the imaging device 6 newly includes a selection circuit 42 disposed between the AD converter 35 and the horizontal operation circuits 36a and 36b. The selection circuit 42 has a circuit configuration similar to that of the selection circuit 40 depicted in FIG. 4A or FIG. 4B. That is, the selection circuit 42 includes the transistors Q1 and Q2 depicted in FIG. 4A, or the transistors Q11, Q12, Q21, and Q22 depicted in FIG. 4B.

In the selection circuit 40 and the selection circuit 42, for example, when the transistor Q1 or the transistors Q11 and Q12 enter the on state and the transistor Q2 or the transistors Q21 and Q22 enter the off state, the AD converter 35 converts the pixel signal S10 into a digital pixel signal on the basis of the control of the horizontal operation circuit 36a and outputs the digital pixel signal to the signal processing circuit 37a. The signal processing circuit 37a outputs a result of calculation processing based on the digital pixel signal to the vertical drive circuit 34b. Subsequently, the memory array section 20 generates the convolution signal S20 on the basis of the control of the vertical drive circuit 34b.

After that, in the selection circuit 40 and the selection circuit 42, when the transistor Q1 or the transistors Q11 and Q12 enter the off state and the transistor Q2 or the transistors Q21 and Q22 enter the on state, the AD converter 35 converts the convolution signal S20 into a digital convolution signal on the basis of the control of the horizontal operation circuit 36b and outputs the digital convolution signal to the signal processing circuit 37b. The signal processing circuit 37b outputs a result of calculation processing based on the digital convolution signal to the outside.

According to the present embodiment described above, the AD converter 35 is common to the pixel array section 10 and the memory array section 20. Thus, it is possible to make the imaging device 6 according to the present embodiment smaller than an imaging device in which the AD converter is provided for each of the pixel array section 10 and the memory array section 20. In particular, the region of the AD converter occupies a large area within the device. Thus, using the AD converter in common yields a significant effect for a reduction in circuit area.

### Fourth Modified Example

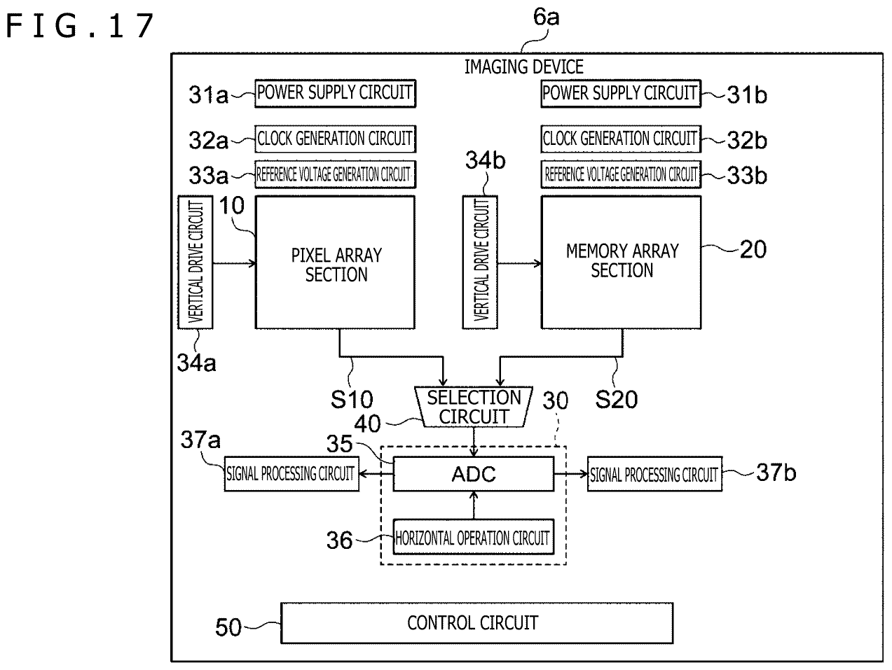

FIG. 17 is a block diagram depicting a schematic configuration of an imaging device according to a modified example of the sixth embodiment. In the present modified example, components similar to those of the sixth embodiment are denoted by the same reference signs, and the detailed descriptions thereof are omitted.

In an imaging device 6a depicted in FIG. 17, the AD converter 35 and the horizontal operation circuit 36 form the common circuit 30. Thus, the imaging device 6a does not require the selection circuit 42 described in the sixth embodiment. In the present modified example, the pixel signal S10 or the convolution signal S20 selected by the selection circuit 41 is input to the AD converter 35. In a case where the pixel signal S10 is input, the AD converter 35 digitally converts this pixel signal S10 to generate a digital pixel signal. Subsequently, the horizontal operation circuit 36 outputs this digital pixel signal to the signal processing circuit 37a. The signal processing circuit 37a outputs a result of calculation processing based on the digital pixel signal to the vertical drive circuit 34b.

Meanwhile, in a case where the convolution signal S20 is input, the AD converter 35 digitally converts this convolution signal S20 to generate a digital convolution signal. Subsequently, the horizontal operation circuit 36 outputs this digital convolution signal to the signal processing circuit 37b. The signal processing circuit 37b outputs a result of calculation processing based on the digital convolution signal to the outside.

According to the present embodiment described above, the AD converter 35 and the horizontal operation circuit 36 are common to the pixel array section 10 and the memory array section 20 to eliminate the necessity of the selection circuit 42. Thus, the space for disposing the selection circuit 42 can be omitted, thereby making it possible to make the imaging device small compared to the fifth embodiment.

### Seventh Embodiment

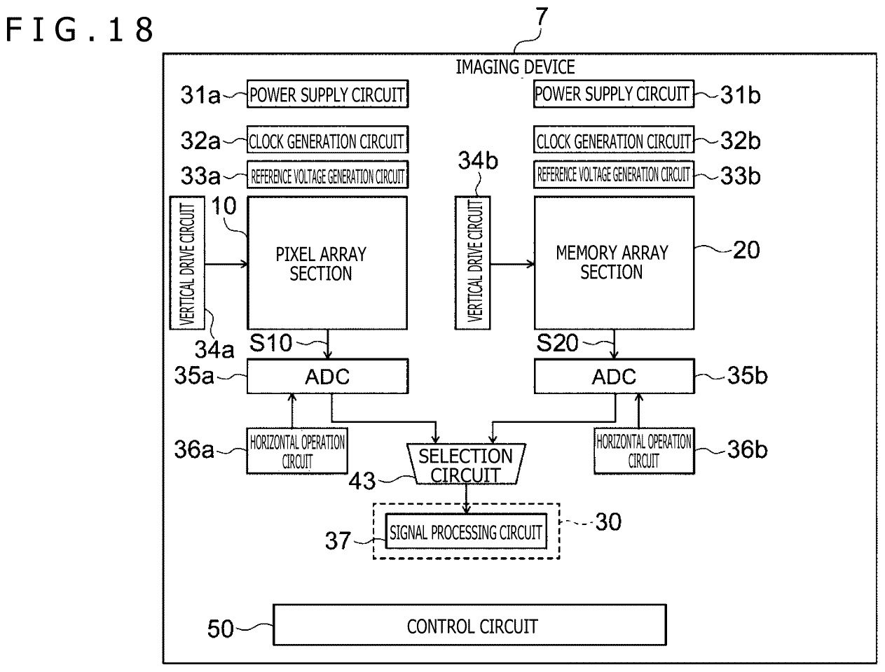

FIG. 18 is a block diagram depicting a schematic configuration of an imaging device according to a seventh embodiment. Also in the present embodiment, components similar to those of the first embodiment are denoted by the same reference signs, and the detailed descriptions thereof are omitted. The differences from the first embodiment are mainly described.

In an imaging device 7 according to the present embodiment, as depicted in FIG. 18, the signal processing circuit 37 is the common circuit 30. Further, the imaging device 6 includes a selection circuit 43 (third selection circuit) disposed between the AD converters 35a (first AD converter) and 35b (second converter) and the signal processing circuit 37, in place of the selection circuit 40. The selection circuit 43 selects a connection between the AD converter 35a and the signal processing circuit 37, or a connection between the AD converter 35b and the signal processing circuit 37. Further, the selection circuit 43 has a circuit configuration similar to that of the selection circuit 40 depicted in FIG. 4A or FIG. 4B. That is, the selection circuit 43 includes the transistors Q1 and Q2 depicted in FIG. 4A, or the transistors Q11, Q12, Q21, and Q22 depicted in FIG. 4B.

In the selection circuit 43, for example, when the transistor Q1 or the transistors Q11 and Q12 enter the on state and the transistor Q2 or the transistors Q21 and Q22 enter the off state, the AD converter 35a converts the pixel signal S10 into a digital pixel signal on the basis of the control of the horizontal operation circuit 36a and outputs the digital pixel signal to the signal processing circuit 37. The signal processing circuit 37 outputs a result of calculation processing based on the digital pixel signal to the vertical drive circuit 34b. Subsequently, the memory array section 20 generates the convolution signal S20 on the basis of the control of the vertical drive circuit 34b.

After that, in the selection circuit 43, when the transistor Q1 or the transistors Q11 and Q12 enter the off state and the transistor Q2 or the transistors Q21 and Q22 enter the on state, the AD converter 35b converts the convolution signal S20 into a digital convolution signal on the basis of the control of the horizontal operation circuit 36b and outputs the digital convolution signal to the signal processing circuit 37. The signal processing circuit 37 outputs a result of calculation processing based on the digital convolution signal to the outside.

According to the present embodiment described above, the signal processing circuit 37 is common to the pixel array section 10 and the memory array section 20. Thus, it is possible to make the imaging device 7 according to the present embodiment smaller than an imaging device in which the signal processing circuit is provided for each of the pixel array section 10 and the memory array section 20.

### Fifth Modified Example

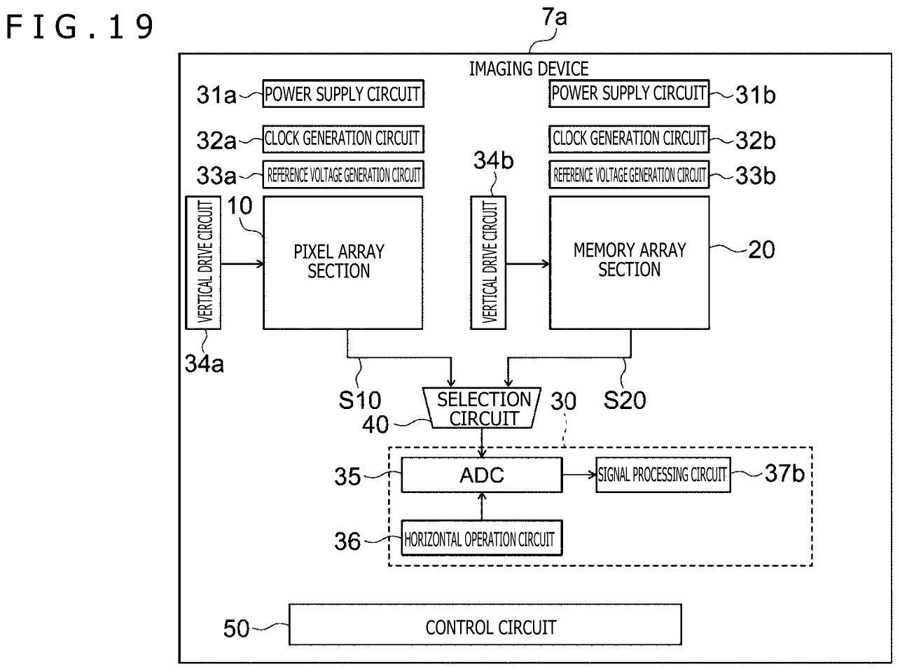

FIG. 19 is a block diagram depicting a schematic configuration of an imaging device according to a modified example of the seventh embodiment. In the present modified example, components similar to those of the seventh embodiment are denoted by the same reference signs, and the detailed descriptions thereof are omitted.

In an imaging device 7a depicted in FIG. 19, the common circuit 30 includes the AD converter 35, the horizontal operation circuit 36, and the signal processing circuit 37. Further, the selection circuit 40 described in the first embodiment is disposed between the pixel array section 10 and the memory array section 20 on one hand and the AD converter 35 on the other hand.

In the selection circuit 40, for example, when the transistor Q1 or the transistors Q11 and Q12 enter the on state and the transistor Q2 or the transistors Q21 and Q22 enter the off state, the pixel signal S10 generated by the pixel array section 10 is input to the AD converter 35 through the selection circuit 40. The AD converter 35 converts the pixel signal S10 into a digital pixel signal on the basis of the control of the horizontal operation circuit 36 and outputs the digital pixel signal to the signal processing circuit 37. The signal processing circuit 37 outputs a result of calculation processing based on the digital pixel signal to the vertical drive circuit 34b. Subsequently, the memory array section 20 generates the convolution signal S20 on the basis of the control of the vertical drive circuit 34b.

After that, in the selection circuit 40, when the transistor Q1 or the transistors Q11 and Q12 enter the off state and the transistor Q2 or the transistors Q21 and Q22 enter the on state, the convolution signal S12 is input to the AD converter 35 through the selection circuit 40. The AD converter 35 converts the convolution signal S20 into a digital convolution signal on the basis of the control of the horizontal operation circuit 36 and outputs the digital convolution signal to the signal processing circuit 37. The signal processing circuit 37 outputs a result of calculation processing based on the digital convolution signal to the outside.

According to the present modified example described above, the peripheral circuits on the output side of the pixel array section 10 and the memory array section 20 are common to the pixel array section 10 and the memory array section 20. Thus, it is possible to make the imaging device small even compared to the seventh embodiment described above.

Note that the combination of common circuits is not limited to the embodiments and modified examples described above. For example, the common circuit 30 may include the clock generation circuit and the AD converter, or the power supply circuit and the vertical drive circuit. Further, the common circuit 30 may include the reference voltage generation circuit, the power supply circuit, and the signal processing circuit, or the clock generation circuit, the power supply circuit, the AD converter, and the horizontal operation circuit.

Further, circuits that are not used in common may be stopped depending on the contents of the operation of the imaging device. For example, in a case where the power supply circuit is not used in common, the power supply circuit 31a of the pixel array section 10 may be stopped during multiply-accumulate operations. In this case, the power consumption of the imaging device can be reduced.

### Eighth Embodiment

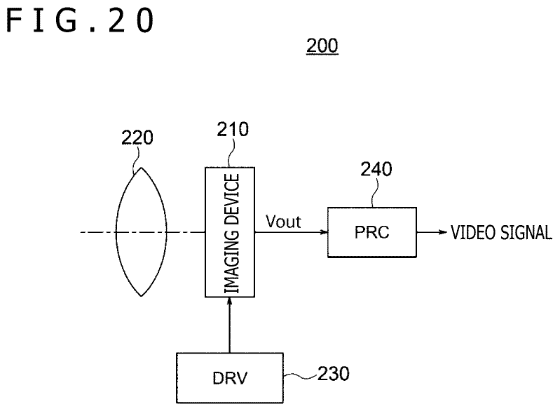

FIG. 20 is a diagram depicting an example of a configuration of electronic equipment according to the fifth embodiment. Electronic equipment 200 according to the present embodiment is a camera system and includes, as depicted in FIG. 20, an imaging device 210, a lens 220, a drive circuit (DRV) 230, and a signal processing circuit (PRC) 240.

As the imaging device 210, any of the imaging devices according to the first embodiment to the seventh embodiment described above can be applied. The lens 220 forms an image of incident light (image light) on the imaging surface.

The drive circuit 230 includes a timing generator (not depicted) configured to generate various timing signals for driving the circuits within the imaging device 210, such as start pulses and clock pulses, and drives the imaging device 210 with predetermined timing signals.

Further, the signal processing circuit 240 performs predetermined signal processing on the output signal of the imaging device 210. The image signal processed by the signal processing circuit 240 is recorded on a recording medium such as a memory. The image information recorded on the recording medium is output in hard copy by a printer or the like. Further, the image signal processed by the signal processing circuit 240 is displayed as a moving image on a monitor including a liquid crystal display or the like.

According to the present embodiment described above, the imaging device according to any one of the embodiments described above is mounted on the electronic equipment 200, such as a digital still camera, as the imaging device 210, thereby making it possible to achieve a highly accurate imaging function.

### Application Example to Mobile Body

The technology according to the present disclosure (present technology) can be applied to various products. For example, the technology according to the present disclosure may be implemented as a device that is mounted on any type of mobile body such as an automobile, an electric vehicle, a hybrid electric vehicle, a motorcycle, a bicycle, a personal mobility, an airplane, a drone, a ship, or a robot.

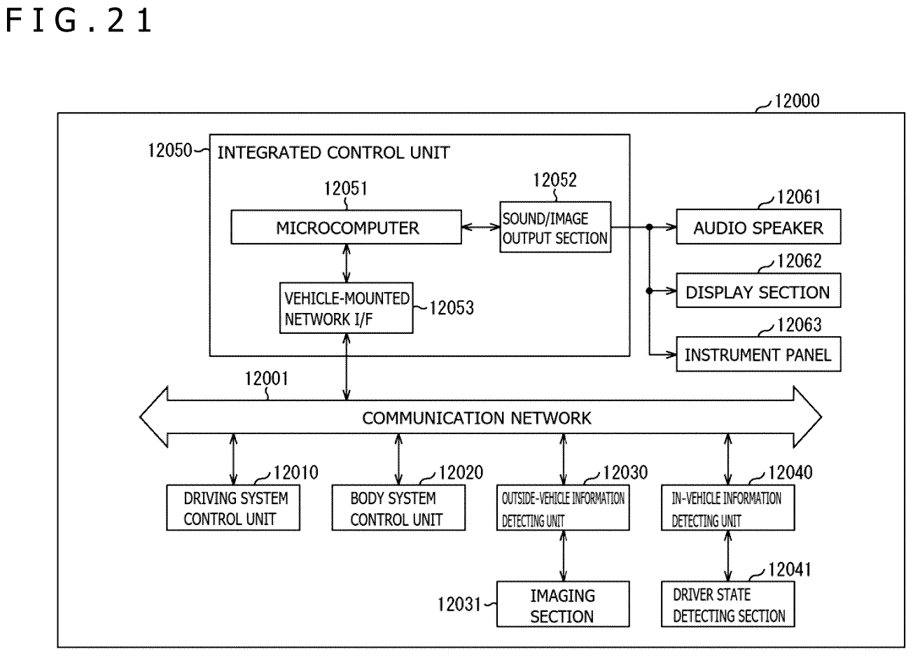

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

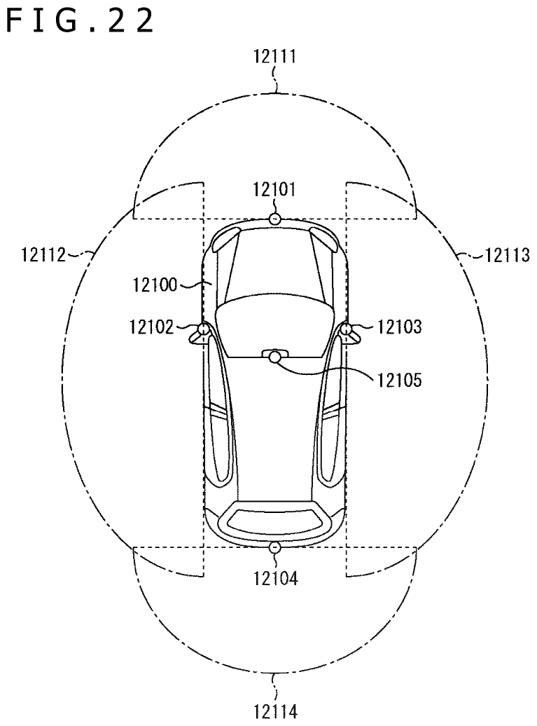

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above, for example. Specifically, the imaging device according to any one of the first embodiment to the seventh embodiment can be applied to the imaging section 12031. By applying the technology according to the present disclosure, the area of the imaging section can be reduced, thereby making it possible to reduce the vehicle control system in size.

Note that the present technology can adopt the following configurations.

(1)

An imaging device including:
a pixel array section configured to output a pixel signal obtained through photoelectric conversion of incident light;
a memory array section configured to output a convolution signal indicating a result of a multiply-accumulate operation on an input signal based on the pixel signal; and
a common circuit common to at least one of input and output sides of the pixel array section and the memory array section.
   (2)

The imaging device according to (1), further including:
a first selection circuit configured to select an electrical connection between the pixel array section and the common circuit, or an electrical connection between the memory array section and the common circuit.
   (3)

The imaging device according to any one of (1) to (3),
in which the pixel array section is disposed on a first substrate, and
the memory array section is disposed on a second substrate stacked on the first substrate.
   (4)

The imaging device according to (3),
in which an output direction of the pixel signal is different from an output direction of the convolution signal.
   (5)

The imaging device according to any one of (1) to 4,
in which the pixel signal and the convolution signal are each an analog signal, and
the common circuit includes an AD converter configured to convert the analog signal into a digital signal.
   (6)

The imaging device according to (5),
in which the common circuit includes a horizontal operation circuit configured to control the AD converter.
   (7)

The imaging device according to (6), in which a plurality of the horizontal operation circuits are provided for the single AD converter.

(8)

The imaging device according to any one of (1) to (7),
in which the pixel array section has a plurality of pixels two-dimensionally arranged,
the memory array section has a plurality of memory cells two-dimensionally arranged, and
the common circuit includes a vertical drive circuit configured to select a pixel row and a memory cell row.
   (9)

The imaging device according to (8),
in which the vertical drive circuit includes
   a register,
   a first voltage adjustment section disposed between the register and the pixel array section, and
   a second voltage adjustment section disposed between the register and the memory array section.
      (10)

The imaging device according to (9),
in which the number of the first voltage adjustment sections is different from the number of the second voltage adjustment sections.
   (11)

The imaging device according to (9),
in which the number of the first voltage adjustment sections is the same as the number of the second voltage adjustment sections.
   (12)

The imaging device according to any one of (8) to (11), further including:
a second selection circuit configured to switch a connection destination of the vertical drive circuit to the pixel array section or the memory array section.
   (13)

The imaging device according to any one of (1) to (12),
in which the common circuit includes a reference voltage generation circuit configured to generate a reference voltage within the imaging device.
   (14)

The imaging device according to (13),
in which the common circuit includes a power supply circuit configured to supply a power supply voltage to the pixel array section and the memory array section.
   (15)

The imaging device according to any one of (1) to (14),
in which the common circuit includes a clock generation circuit configured to generate a clock for setting operating frequencies of the pixel array section and the memory array section.
   (16)

The imaging device according to (15),
in which the clock generation circuit includes a frequency divider for setting the operating frequencies different from each other to the pixel array section and the memory array section.
   (17)

The imaging device according to any one of (1) to (16),
in which the common circuit includes a signal processing circuit configured to process signals obtained through digital conversion of the pixel signal and the convolution signal.
   (18)

The imaging device according to (17), further including:
a first AD converter configured to digitally convert the pixel signal;
a second AD converter configured to digitally convert the convolution signal; and
a third selection circuit configured to select an electrical connection between the first AD converter and the signal processing circuit, or an electrical connection between the second AD converter and the signal processing circuit.
   (19)

Electronic equipment including:
an imaging device including
   a pixel array section configured to output a pixel signal obtained through photoelectric conversion of incident light,
   a memory array section configured to output a convolution signal indicating a result of a multiply-accumulate operation on an input signal based on the pixel signal, and
   a common circuit common to at least one of input and output sides of the pixel array section and the memory array section.
      (20)

A signal processing method including:
outputting a pixel signal obtained through photoelectric conversion of incident light, from a pixel array section; and
outputting a convolution signal indicating a result of a multiply-accumulate operation on an input signal based on the pixel signal, from a memory array section,
in which a common circuit common to at least one of input and output sides of the pixel array section and the memory array section is used to generate and process each of the pixel signal and the convolution signal.

### REFERENCE SIGNS LIST

1 to 7: Imaging device
10: Pixel array section
11: Pixel
20: Memory array section
21: Memory cell
30: Common circuit
31, 31a, 31b: Power supply circuit
34, 34a, 34b: Vertical drive circuit
35, 35a, 35b: AD converter
36, 36a, 36b: Horizontal operation circuit
37, 37a, 37b: Signal processing circuit
40 to 43: Selection circuit
101: First substrate
102: Second substrate
323: Frequency divider
S10: Pixel signal
S20: Convolution signal

1. An imaging device comprising:
a pixel array section configured to output a pixel signal obtained through photoelectric conversion of incident light;
a memory array section configured to output a convolution signal indicating a result of a multiply-accumulate operation on an input signal based on the pixel signal; and
a common circuit common to at least one of input and output sides of the pixel array section and the memory array section.

2. The imaging device according to claim 1, further comprising:
a first selection circuit configured to select an electrical connection between the pixel array section and the common circuit, or an electrical connection between the memory array section and the common circuit.

3. The imaging device according to claim 1,
wherein the pixel array section is disposed on a first substrate, and
the memory array section is disposed on a second substrate stacked on the first substrate.

4. The imaging device according to claim 3,
wherein an output direction of the pixel signal is different from an output direction of the convolution signal.

5. The imaging device according to claim 1,
wherein the pixel signal and the convolution signal are each an analog signal, and
the common circuit includes an AD converter configured to convert the analog signal into a digital signal.

6. The imaging device according to claim 5,
wherein the common circuit includes a horizontal operation circuit configured to control the AD converter.

7. The imaging device according to claim 6,
wherein a plurality of the horizontal operation circuits are provided for the single AD converter.

8. The imaging device according to claim 1,
wherein the pixel array section has a plurality of pixels two-dimensionally arranged,
the memory array section has a plurality of memory cells two-dimensionally arranged, and
the common circuit includes a vertical drive circuit configured to select a pixel row and a memory cell row.

9. The imaging device according to claim 8,
wherein the vertical drive circuit includes
a register,
a first voltage adjustment section disposed between the register and the pixel array section, and
a second voltage adjustment section disposed between the register and the memory array section.

10. The imaging device according to claim 9,
wherein the number of the first voltage adjustment sections is different from the number of the second voltage adjustment sections.

11. The imaging device according to claim 9,
wherein the number of the first voltage adjustment sections is same as the number of the second voltage adjustment sections.

12. The imaging device according to claim 8, further comprising:
a second selection circuit configured to switch a connection destination of the vertical drive circuit to the pixel array section or the memory array section.

13. The imaging device according to claim 1,
wherein the common circuit includes a reference voltage generation circuit configured to generate a reference voltage within the imaging device.

14. The imaging device according to claim 13,
wherein the common circuit includes a power supply circuit configured to supply a power supply voltage to the pixel array section and the memory array section.

15. The imaging device according to claim 1,
wherein the common circuit includes a clock generation circuit configured to generate a clock for setting operating frequencies of the pixel array section and the memory array section.

16. The imaging device according to claim 15,
wherein the clock generation circuit includes a frequency divider for setting the operating frequencies different from each other to the pixel array section and the memory array section.

17. The imaging device according to claim 1,
wherein the common circuit includes a signal processing circuit configured to process signals obtained through digital conversion of the pixel signal and the convolution signal.

18. The imaging device according to claim 17, further comprising:
a first AD converter configured to digitally convert the pixel signal;
a second AD converter configured to digitally convert the convolution signal; and
a third selection circuit configured to select an electrical connection between the first AD converter and the signal processing circuit, or an electrical connection between the second AD converter and the signal processing circuit.

19. Electronic equipment comprising:
an imaging device including
a pixel array section configured to output a pixel signal obtained through photoelectric conversion of incident light,
a memory array section configured to output a convolution signal indicating a result of a multiply-accumulate operation on an input signal based on the pixel signal, and
a common circuit common to at least one of input and output sides of the pixel array section and the memory array section.

20. A signal processing method comprising:
outputting a pixel signal obtained through photoelectric conversion of incident light, from a pixel array section; and
outputting a convolution signal indicating a result of a multiply-accumulate operation on an input signal based on the pixel signal, from a memory array section,
wherein a common circuit common to at least one of input and output sides of the pixel array section and the memory array section is used to generate and process each of the pixel signal and the convolution signal.
